(19) United States
(12) Patent Application Publication
(10) Pub. No.: US 2026/0301728 A1
(43) Pub. Date: Oct. 1, 2026

(54) THERMOACOUSTIC META-STRUCTURE

(71) Applicant: The Board of Regents for the Oklahoma Agricultural and Mechanical Colleges, Stillwater, OK (US)

(72) Inventors: James Manimala, Stillwater, OK (US); Samarjith Biswas, Tucson, AZ (US)

(21) Appl. No.: 19/705,163

(22) Filed: Jun. 11, 2026

Related U.S. Application Data
(63) Continuation of application No. PCT/US24/58048, filed on Dec. 2, 2024.
(60) Provisional application No. 63/609,237, filed on Dec. 12, 2023.

(51) Int. Cl. G10K 11/168; G10K 11/172

(52) U.S. Cl. CPC G10K 11/168; G10K 11/172

(57) ABSTRACT

A thermoacoustic metastructure and method of construction and use thereof are herein disclosed. The thermoacoustic metastructure comprises a resonator, a porous stack, and a thermopile. The resonator comprises a wall defining an opening and having a first end forming an aperture to receive a working fluid and a second end forming an end-stop. The resonator has a resonator length between the first end and the second end of the wall. The porous stack has a first side and a second side and has a plurality of pores disposed therethrough. The porous stack is disposed in the opening of the resonator and in fluid communication with the working fluid. The thermopile comprises a plurality of thermoelectric transducers electrically coupled to form a thermopile circuit operable to generate electrical energy. The thermoelectric transducers are coupled to a first location and a second location of the porous stack.

### CROSS-REFERENCE TO RELATED APPLICATIONS

The present is a continuation application claiming priority to PCT/US24/58048 filed Dec. 2, 2024 which claims priority to Provisional Patent Application U.S. Ser. No. 63/609,237 titled “Thermoacoustic Meta-Structure” filed on Dec. 12, 2023, the entire content of which is hereby expressly incorporated herein by reference in its entirety.

### STATEMENT REGARDING FEDERALLY SPONSORED RESEARCH OR DEVELOPMENT

This invention was made with government support under 2033399 awarded by the National Science Foundation. The government has certain rights in the invention.

### BACKGROUND

Thermoacoustics generally involve acoustics in gases with diffusive effects, and more specifically, to thermoacoustic effects induced by heated surfaces, with a focus on maintaining large-amplitude acoustic oscillations or vice versa. These thermoacoustic effects arise from unstable configurations, where oscillating flow occurs over a non-isothermal surface or vice versa.

Thermoacoustic systems are divided into two major groups-Thermoacoustic Engines (TAEs) and Thermoacoustic Refrigerators (TARs). TAE converts heat energy into acoustic energy, and TAR converts acoustic energy into thermal energy. Thermoacoustics overcomes many environmental problems in refrigeration, including the emission of harmful chlorofluorocarbons (CFCs) and hydrochlorofluorocarbons (HCFCs). Thermoacoustic electric generators have the potential to convert acoustic (or thermal) energy into electrical energy, while thermoacoustic refrigerators can provide cooling effects in areas where there is no access to electricity.

Acoustic energy harvesting is an expanding field offering sustainable and cost-effective powering technologies solutions. One of the key benefits of acoustic energy harvesting is the ability to transform ambient sound into usable electricity, which reduces the need for external power sources. The most common methods for harvesting acoustic energy are electromagnetic and piezoelectric based. Electromagnetic energy harvesting relies on converting acoustic energy into electrical energy via electromagnetic induction. Piezoelectric energy harvesting involves the use of piezoelectric materials, such as lead zirconate titanate (PZT), that convert mechanical stress into electrical energy. Piezoelectric materials can generate electricity through mechanical deformation, caused by incident sound waves. Piezoelectric materials, however, have limitations such as the limited ability to convert energy (since the quantity of energy they can capture depends on the frequency and amplitude of the mechanical force being applied), high cost, sensitivity to environmental factors, low output voltage, and sensitivity to shock and vibration, which may result in failure or can lead to unpredictable output signals. Additionally, the endurance of piezoelectric materials can pose a challenge, as prolonged usage may lead to degradation and performance decline.

Additionally, airborne noise mitigation is a significant challenge in several engineering applications, particularly in the aerospace realm, where it diminishes efficiency, hampers stealth, contributes to environmental pollution, and curtails commercial viability. The FAA's prognosis on aviation noise mitigation states that “Absent further advances in noise reduction technologies and fleet evolution, the remaining problem must be addressed primarily through operational procedures and airport-specific noise compatibility programs.” This points to the critical need to develop new technologies for noise mitigation in order to advance towards more sustainable aviation globally. Conventional technologies have reached practical limits in addressing airborne noise, especially for low frequency (<~1,000 Hz) spectra. Because aircraft turbofan engine core-noise has significant low frequency (<1,000 Hz) components, core noise is unaddressed using conventional acoustic liners or damping technology.

### SUMMARY

The thermoacoustic phenomenon manifests due to an instability caused by pressure waves propagating in an acoustic resonator inducing oscillations in a porous stack, the ends of which are held under an imposed thermal gradient, thereby creating fluctuations in the rate of heat transfer. This in turn generates further pressure oscillations, leading to an unstable acoustic mode that can be harnessed without the need for any moving parts.

Recent advancements in manufacturing, particularly in 3D printing technology, have opened new avenues for designing and fabricating complex metamaterial-inspired geometries thereby overcoming the limitations of traditional thermoacoustic devices, which often rely on suboptimal materials. A metamaterial may be a synthetic material (not naturally occurring) with properties that are engineered into the structure, rather than coming solely from the material(s) that the metamaterial is made of. The material may contribute to the properties, but it is the combination of the material and the engineered structure that provides the properties to the metamaterial. By incorporating new microstructures at the material scale, these metastructures can become more adaptive in response to dynamic phenomena, allowing the thermoacoustic effects to be captured by a thermoacoustic system having a smaller form factor than traditional thermoacoustic devices. Moreover, leveraging the precise control offered by advanced manufacturing techniques to design and fabricate intricate geometries may enhance the interaction between the working fluid and the stack. This optimization may significantly improve thermal and acoustic interactions, leading to higher energy conversion efficiency by the thermoacoustic system.

Thus, a need exists for a thermoacoustic system and method having improved performance of energy capture, durability, and environmental resilience compared to conventional piezoelectric materials. Such a thermoacoustic system having improved performance of energy capture, durability, and environmental resilience is herein disclosed. Moreover, the thermoacoustic system may mitigate aircraft turbofan engine core-noise at the low frequencies (e.g., <1,000 Hz). For example, as disclosed herein, utilizing available thermal gradients across the engine's core-wall, the thermoacoustic system may be employed to embed thermoacoustic elements into liner metastructures.

The thermoacoustic system includes a porous structure, referred to as the stack, which has geometric and thermophysical properties that are tuned to optimize the energy transduction process. The energy transduction process is facilitated through the integration of a thermoacoustic refrigerator and a thermoelectric generator.

A thermoacoustic metastructure (TAMS) disclosed herein uses an acousto-thermo-electric transduction scheme to convert sound waves into usable electrical energy. The TAMS comprises a porous stack with tuned geometric and thermophysical properties coupled with a thermoacoustic refrigerator and/or a thermoelectric generator. The energy transduction process is achieved through a combination of instabilities caused by acoustic pressure waves propagating through a fluid medium in a resonator. The acoustic-thermoelectric transduction scheme can be employed to harvest usable electrical power. For example, the TAMS may generate a voltage of about 33 mV across a 1 Ohm load at an output power of 19.8 μW. The temperature gradient and efficiency may increase between acoustic excitation frequencies of 115 and 120 Hz and stack positions closer to the acoustic source may be preferable. The TAMS may be used for noise mitigation in conjunction with energy harvesting, and may be utilized in modular infrastructural building blocks.

The thermoacoustic metastructure and method of use thereof include a thermoacoustic metastructure comprising a resonator, a porous stack, and a thermopile. The resonator comprises a surrounding wall defining an opening. The surrounding wall has a first end and a second end opposite the first end. The first end forms an aperture operable to receive a working fluid. The second end forms an end-stop. The resonator has a resonator length between the first end and the second end of the surrounding wall. The porous stack has a first side and a second side opposite the first side. The porous stack has a plurality of pores disposed therethrough. The porous stack may be disposed in the opening defined by the surrounding wall of the resonator and in fluid communication with the working fluid. The thermopile comprises a plurality of thermoelectric transducers electrically coupled to form a thermopile circuit operable to generate electrical energy. The thermoelectric transducers may be coupled to a first location and a second location of the porous stack, where the first location is longitudinally spaced from the second location.

Further disclosed is an infrastructural barrier comprising a plurality of thermoacoustic metastructures and at least one power circuitry. The plurality of thermoacoustic metastructures each comprise a resonator, a porous stack, a thermopile, and a modular housing. The resonator has a surrounding wall defining an opening. The surrounding wall has a first end and a second end opposite the first end. The first end forms an aperture operable to receive a working fluid. The second end forms an end-stop. The resonator has a resonator length between the first end and the second end. The porous stack has a first side and a second side opposite the first side. The porous stack may be disposed in the opening defined by the surrounding wall and in fluid communication with the working fluid. The thermopile comprises a plurality of thermoelectric transducers electrically coupled to form a thermopile circuit operable to generate electrical energy. The thermoelectric transducers may be alternatingly coupled to a first location and a second location of the porous stack, where the first location may be spaced longitudinally from the second location. The modular housing may support the resonator, the porous stack, and the thermopile. The at least one power circuitry may be electrically coupled to the thermopile circuit of one or more thermoacoustic metastructure and be operable to receive the generated electrical energy. The modular housing of each of the plurality of thermoacoustic metastructures may be interlocked with at least one adjacent thermoacoustic metastructure.

Further disclosed is a method of making a thermoacoustic metastructure. The method comprises, in any order, positioning the porous stack having first and second ends into a resonator; and connecting the thermopile to the first location and the second location of the porous stack, where the first location is longitudinally spaced from the second location.

Further disclosed is a method of using the thermoacoustic metastructure. The method comprises: placing the resonator proximate a sound source; and receiving sound waves through the first end of the resonator to cause a temperature gradient to form between the first location and the second location whereby the thermopile generates electrical energy based upon the temperature gradient.

The foregoing Summary provides an overview of certain selected implementations or embodiments disclosed herein, and is not intended to describe every aspect, embodiment, implementation, feature, or advantage of the disclosure exhaustively or comprehensively. Therefore, this Summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

The details of one or more implementations of the subject matter of this specification are set forth in the accompanying drawings and the description below. Other aspects, features and advantages will become apparent from the description, the drawings, and the claims.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1A is a diagram of an exemplary embodiment of a thermoacoustic refrigerator constructed in accordance with the present disclosure.

FIG. 1B is a diagram of another exemplary embodiment of a thermoacoustic refrigerator constructed in accordance with the present disclosure.

FIG. 2A is a first cross-section of an exemplary embodiment of the stack of the thermoacoustic refrigerator of FIG. 1A, constructed in accordance with the present disclosure.

FIG. 2B is a second cross-section of an exemplary embodiment of the stack of the thermoacoustic refrigerator of FIG. 1A, constructed in accordance with the present disclosure.

FIG. 3A is an exemplary embodiment of a temperature gradient graph in accordance with a first experiment.

FIG. 3B is an exemplary embodiment of a coefficient of performance (COP) graph in accordance with the first experiment.

FIG. 4 is an illustration of an exemplary embodiment of a thermoacoustic metastructure used in accordance with the present disclosure to convert acoustic energy into electrical energy and thereby dampen noised caused by the acoustic energy.

FIG. 5A is a diagram of an exemplary embodiment of the thermoacoustic metastructure of FIG. 4, constructed in accordance with the present disclosure.

FIG. 5B is a transparent perspective view of an exemplary embodiment of a modular cell of the thermoacoustic metastructure of FIG. 4, constructed in accordance with the present disclosure.

FIG. 5C is a cut-away perspective view of the modular cell, constructed in accordance with the present disclosure.

FIG. 5D is a circuit diagram of an exemplary embodiment of a thermopile, constructed in accordance with the present disclosure.

FIG. 6A is an exemplary embodiment of a temperature gradient graph constructed in accordance with the present disclosure and a second experiment.

FIG. 6B is an exemplary embodiment of a normalized temperature gradient graph constructed in accordance with the present disclosure and the second experiment.

FIG. 6C, shown therein is an exemplary embodiment of a coefficient of performance (COP) graph in accordance with the second experiment.

FIG. 7A is an exemplary embodiment of a temperature gradient graph for stacks of varying lengths, in accordance with the second experiment.

FIG. 7B is an exemplary embodiment of a coefficient of performance (COP) graph for stacks of varying lengths, in accordance with the second experiment.

FIG. 8A is an exemplary embodiment of a temperature gradient graph for stacks of varying porosity, in accordance with the second experiment.

FIG. 8B is an exemplary embodiment of a coefficient of performance (COP) graph for stacks of varying porosity, in accordance with the second experiment.

FIG. 9A is an exemplary embodiment of a temperature gradient graph for stacks of varying thermal conductivity, in accordance with the second experiment.

FIG. 9B, shown therein is an exemplary embodiment of a coefficient of performance (COP) graph for stacks of varying thermal conductivity, in accordance with the second experiment.

FIG. 10A is an exemplary embodiment of a temperature gradient graph for stacks at varying positions, in accordance with the second experiment.

FIG. 10B is an exemplary embodiment of a coefficient of performance (COP) graph for stacks at varying positions, in accordance with the second experiment.

FIG. 11A is an illustration of an exemplary embodiment of a graph of experimental vs analytical energy output for a resin stack constructed in accordance with the second experiment

FIG. 11B is an illustration of an exemplary embodiment of a graph of experimental vs analytical energy output for a resin stack based on time constructed in accordance with the second experiment.

FIG. 12A is a first graph of sound transmission loss by time across an exemplary stack in accordance with the second experiment.

FIG. 12B is a second graph of sound transmission loss by frequency across an exemplary stack in accordance with the second experiment.

FIGS. 13A-13D, shown therein are graphs of exemplary embodiments of comparisons of experimental data and simulation data for combinations of stacks of FIG. 1 in accordance with the second experiment.

FIG. 14A is a perspective, transparent view of an exemplary embodiment of a non-linear, e.g., spiral, resonator constructed in accordance with the present disclosure.

FIG. 14B shows a cross-sectional view of the spiral resonator of FIG. 14A across a longitudinal axis of the spiral resonator.

FIG. 14C shows a cross-sectional view of the spiral resonator of FIG. 14A along the longitudinal axis of the spiral resonator.

FIG. 15 is an illustration of an exemplary embodiment of a graph of temperature gradients for the spiral resonator of FIGS. 14A-14C, constructed in accordance with the present disclosure and a third experiment.

FIG. 16 is a partially exploded perspective view of an exemplary embodiment of a spiral stack constructed in accordance with the present disclosure.

FIG. 17A is a diagram of an exemplary embodiment of a graph of varying spiral stack radii and gain factor of length of the spiral stack of FIG. 16, constructed in accordance with the present disclosure and a fourth experiment.

FIG. 17B is a diagram of an exemplary embodiment of a graph of varying spiral stack radii and resonance frequency of the spiral stack of FIG. 16, constructed in accordance with the present disclosure and the fourth experiment.

FIG. 17C is a diagram of an exemplary embodiment of a graph of temperature gradient per frequency of the spiral stack of FIG. 16, constructed in accordance with the present disclosure and the fourth experiment.

FIG. 18A is a partially transparent perspective view of an exemplary embodiment of a modular resonator constructed in accordance with the present disclosure.

FIG. 18B is a top view of an exemplary embodiment of the stack constructed in accordance with the present disclosure.

FIG. 18C is a perspective view of an exemplary embodiment of the stack constructed in accordance with the present disclosure.

FIG. 19A is an illustration of an exemplary embodiment of a jet engine assembly having a thermoacoustic liner (e.g., cowling) constructed in accordance with the present disclosure surrounding a jet engine to convert acoustic energy generated by the jet engine into electrical energy and dampen the acoustic energy.

FIG. 19B is a perspective cut-away view of a portion of an exemplary embodiment of the thermoacoustic liner of FIG. 19A, constructed in accordance with the present disclosure.

FIG. 19C is an illustration of an exemplary embodiment of the thermoacoustic liner of FIG. 19A having a plurality of resonators disposed adjacent to each other, constructed in accordance with the present disclosure.

FIG. 20 is a diagram of an exemplary embodiment of a folded-core thermoacoustic liner constructed in accordance with the present disclosure.

FIG. 21 is a diagram of an exemplary embodiment of a thermoacoustic system constructed in accordance with the present disclosure.

FIG. 22A is a diagram of an exemplary embodiment of another thermoacoustic system constructed in accordance with the present disclosure.

FIG. 22B is a diagram of an exemplary embodiment of a structural feature of the thermoacoustic system of FIG. 22A, constructed in accordance with the present disclosure.

FIG. 22C is a diagram of an exemplary embodiment of a TAMS harvester of the thermoacoustic system of FIG. 22A constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the disclosure as described herein. Where a range of numerical values is stated herein as being less than a stated value, the range is nevertheless bounded on its lower end by a non-zero value. It is not intended that the scope of the disclosure be limited to the specific values recited when defining a range. All ranges are inclusive and combinable.

Circuitry, as used herein, may be analog and/or digital components, or one or more suitably programmed processors (e.g., microprocessors) and associated hardware and software, or hardwired logic. Also, “circuitry” may perform one or more functions. The term “processor” may include hardware, such as a microprocessor, an application specific integrated circuit (ASIC), a field programmable gate array (FPGA), a Digital Signal Processor (DSP), a combination of hardware and software, software, and/or the like. The term “processor” as used herein means a single processor or multiple processors working independently or together to collectively perform a task.

Software may include one or more computer readable instruction that when executed by one or more processor, causes the processor to perform a specified function. It should be understood that the algorithms described herein may be stored on one or more non-transitory computer-readable medium. Exemplary non-transitory computer-readable media may include a non-volatile memory, a volatile memory, a random-access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, phase change memory, combinations thereof, and/or the like. Such non-transitory computer-readable media may be electrically based, optically based, magnetically based, material-phase based, resistive based, and/or the like. Further, the messages described herein may be generated by the components and result in various physical transformations.

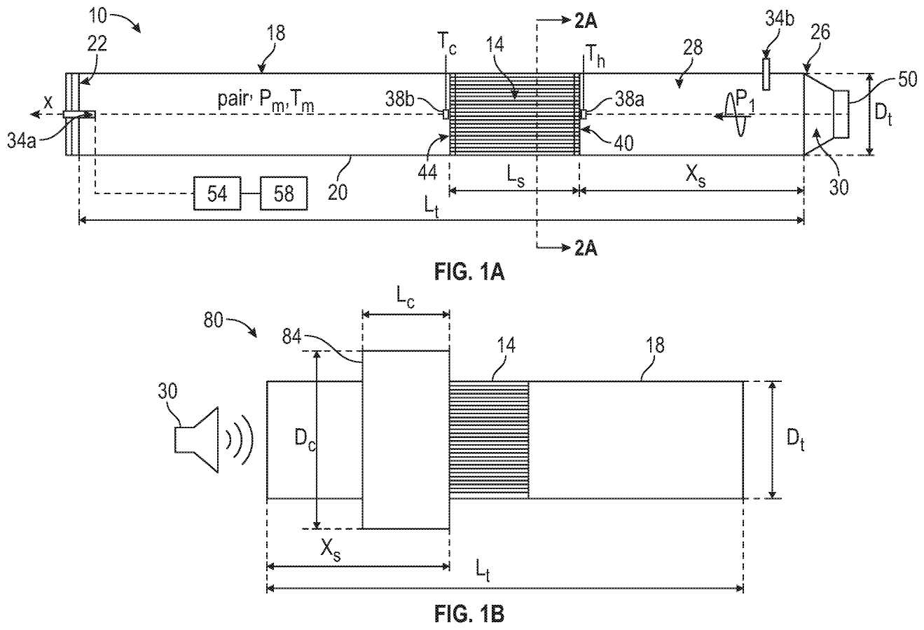

Referring now to FIG. 1A, shown therein is a diagram of an exemplary embodiment of a thermoacoustic refrigerator 10 (hereinafter TAR 10) constructed in accordance with the present disclosure. As shown, the TAR 10 comprises a porous stack 14 disposed within a resonator 18 and between an end-stop 22 and an aperture 26 of the resonator 18. The resonator 18 may comprise as surrounding wall 20 (e.g., tube) defining an opening 28 into which the porous stack 14 is disposed. The porous stack 14 may be disposed coaxially with the resonator 18 and along a longitudinal axis, x, of the resonator 18. The aperture 26 may receive acoustic signals into the resonator 18. The resonator 18 may have a working fluid disposed therein, such as ambient air, carrying the acoustic signal along a propagation path, P₁. As these acoustic signals propagate in the resonator 18, oscillations are indued in the porous stack 14, thereby causing a thermal gradient on opposing ends of the porous stack 14.

Generally, the aperture 26 may receive acoustic signals from an environment in which the TAR 10 is placed. As shown in FIG. 1A, for example, during experimentation as described below, an acoustic driver 30 may be positioned at the aperture 26 of the resonator 18 to generate acoustic signals. The acoustic driver 30 may be, for example, a speaker.

In one embodiment, the TAR 10 may include one or more acoustic receivers 34 to measure acoustic power of the acoustic signals at varying locations within the resonator 18. The one or more acoustic receivers 34 may be, for example, a microphone or a piezoelectric device. For simplicity, the one or more acoustic receivers 34 may be referred to as a microphone 34. For example, a first microphone 34a may be positioned at the end-stop 22 while a second microphone 34b may be positioned near the aperture 26.

In one embodiment, the porous stack 14 of the TAR 10 may be provided with one or more temperature sensor 38, such as a first temperature sensor 38a at a first side 40 (e.g., first location) of the porous stack 14 (also referred to as a ‘hot’ side) to measure a first temperature, Tₕ, and a second temperature sensor 38b as a second side 44 (e.g., second location) of the porous stack 14 (also referred to as a ‘cold’ side) to measure a second temperature, T_{c}.

In one embodiment, the porous stack 14 may have a stack length, Lₛ, while the resonator 18 has a resonator length, Lₜ. The resonator 18 may have a resonator diameter, Dₜ, and the porous stack 14 may have a stack diameter configured to be placed within, the opening 28 and inline with, the resonator 18. The porous stack 14 may be disposed at a location within the resonator 18, along the longitudinal axis, x, at a distance, xₛ, from the aperture 26 of the resonator 18.

In one embodiment, the temperature sensors 38 may be a K-type digital thermocouple with a resolution of 0.1° C., however, in other embodiments, alternative types of temperature sensors 38 may be utilized to measure the respective temperatures, T.

In one embodiment, the end-stop 22 may be constructed of an acoustic-dampening material, such as a rubber, or a hard rubber, end-stop. In one embodiment, the resonator 18 of the TAR 10 may be constructed of an acoustically rigid, yet smooth material able to sustain a plane wave along the resonator 18's axial direction and preferably with low thermal conductivity. For example, the resonator 18 can be constructed of a material(s) with low thermal conductivity, such as acrylic or high-performance polymers such as polycarbonate or PEEK, which may be ideal for minimizing thermal losses while maintaining acoustic reflectivity. Metals are less desirable due to high thermal conductivity. Desirable properties for the material(s) forming the resonator 18 include low thermal conductivity, high acoustic reflectivity, mechanical stability, proper density for impedance matching, and compatibility with manufacturing techniques.

In some embodiment, the TAR 10 may further include a processor 54 communicably coupled to a memory 58 and to the temperature sensors 38 and/or the microphones 34 to receive and/or record signals received by the temperature sensors 38 and/or the microphones 34.

The processor 54 may be implemented as a single processor or multiple processors working together, or independently, as described herein. It is to be understood, that in certain embodiments using more than one processor 54, the processor 54 may be located remotely from one another, located in the same location, or comprising a unitary multi-core processor. The processor 54 may be capable of reading and/or executing processor-executable code and/or capable of creating, manipulating, retrieving, altering, and/or storing data structures into a memory 58 such as in a database, datastore, remote datastore, or other datastructure, either local or remote.

Exemplary embodiments of the processor 54 may include, but are not limited to, a digital signal processor (DSP), a central processing unit (CPU), a field programmable gate array (FPGA), a microprocessor, a multi-core processor, an application specific integrated circuit (ASIC), a graphic processing unit (GPU), a tensor processing unit (TPU), combinations thereof, and/or the like, for example. The processor 54 may be capable of communicating with the memory 58 via a path (e.g., a data bus).

The processor 54 may be further capable of interfacing and/or communicating with the microphones 34. For example, the processor 54 may be capable of exchanging signals (e.g., analog, digital, optical, and/or the like) with the microphones 34 to receive an indication of acoustic power of the acoustic signal within the resonator 18.

The memory 58 may be one or more non-transitory processor-readable medium. The memory 58 may store information received from components of the TAR 10, the database, and/or processor-executable code that, when executed by the processor 54, causes the processor 54 to perform an action such as communicate with or control one or more component of the TAR 10.

In some embodiments, the memory 58 may be located in the same physical location as the processor 54, and/or one or more memory 58 may be located remotely from the processor 54. For example, the memory 58 may be located remotely from the processor 54 and communicate with the processor 54 via a network (such as via wired or wireless communications). Additionally, in some embodiments when more than one memory 58 is used, a first memory 58 may be located in the same physical location as the processor 54, and additional memory 58 may be located in a location physically remote from the processor 54. Additionally, the memory 58 may be implemented as a “cloud” non-transitory processor-readable medium (i.e., one or more memory 58 may be partially or completely based on or accessed using the internet).

Referring now to FIG. 1B, shown therein is a diagram of an exemplary embodiment of a thermoacoustic refrigerator 80 constructed in accordance with the TAR 10, described above, except that the thermoacoustic refrigerator 80 further includes an expansion chamber 84 disposed between the acoustic driver 30 and the porous stack 14. In some embodiments, the expansion chamber 84 may be disposed adjacent to the porous stack 14.

In one embodiment, the expansion chamber 84 may have a length, Lc, and a diameter, Dc. Shorter expansion chambers lower the resonant frequency, thus altering the thermal energy conversion characteristics of the thermoacoustic refrigerator 80. As a length ratio of the chamber to the resonator 18 increases, the peak temperature gradient shifts towards lower frequencies. However, the acoustic power shifts towards higher frequencies with increasing expansion chamber length, Lc.

In one embodiment, the temperature gradient shows a pronounced peak shift with increases in a diameter ratio between the expansion chamber 84 and the resonator 18. At a ratio of

$$\frac{{D}_{C}}{{D}_{t}} = 1$$

(side chamber diameter same as the resonator), the peak temperature gradient occurs at approximately 170 Hz and is around 21° C. As the ratio increases, the peak temperature gradient shifts towards lower frequencies, with the highest gradient observed at around 150 Hz for a

$$\frac{{D}_{C}}{{D}_{t}}$$

ratio of 3. This shift indicates that increasing the diameter, Dc, of the expansion chamber 84 affects the thermal-acoustic coupling efficiency and results in a lower resonant frequency where the maximum temperature gradient occurs. Additionally, it is observed that the peak acoustic power also shifts to lower frequencies as the

$$\frac{{D}_{C}}{{D}_{t}}$$

ratio increases. For a ratio of

$$\frac{{D}_{C}}{{D}_{t}} = 1 ,$$

the peak acoustic power is observed at approximately 170 Hz, reaching around 2 W. As the diameter ratio increases to 3, the peak shifts to about 150 Hz with a corresponding increase in peak power. This suggests that a larger expansion chamber diameter, Dc, not only shifts the resonance frequency but also alters acoustic impedance.

As the diameter ratio increases from 1 to 4.5, the maximum acoustic power significantly increases from about 10 W to around 90 W, indicating that a larger expansion chamber 84 enhances the power output by reducing acoustic impedance. Similarly, the maximum temperature gradient also rises with increasing diameter ratio, moving from approximately 20° C. at

$$\frac{{D}_{C}}{{D}_{t}} = 1$$

to about 24° C. at

$$\frac{{D}_{C}}{{D}_{t}} = 4.5 .$$

This suggests that a larger expansion chamber diameter, Dc, improves the thermal efficiency by enhancing thermoacoustic coupling and reducing thermal losses. Overall, it is observed that increasing the expansion chamber diameter, Dc, positively affects both the acoustic power and temperature gradient.

Referring back to FIG. 1A, the TAR 10 may be used as part of a first experiment. In the first experiment, the resonator 18 may have a diameter, Dₜ, of 0.101 m and a length, Lₜ, of 1.524 m. Circuitry 50 may comprise a function generator coupled with a signal conditioner and amplifier to provide an input excitation for the acoustic driver 30. The acoustic driver 30 may be implemented as 50 W speaker. The circuitry 50 caused a sine wave was passed through the acoustic driver 30 to generate the sound wave. The first experiment, as described below, was conducted under ambient temperature and atmospheric pressure. Therefore, a temperature gradient develops between the first location, e.g., the first side 40 (the hot side), and the second location, e.g., the second side 44 (the cold side), of the porous stack 14 as long as the sound wave passes through the porous stack 14.

In the first experiment, the microphones 34 are provided with a resolution of 0.1 dB and are used to verify a source-side (via the second microphone 34b) and receiver-side (via the first microphone 34a) sound pressure levels. A processor 54 is used to record all data received, such as from one or more of the microphones 34 and the input excitation applied to the acoustic driver 30. Acoustic excitation is provided to the resonator 18 via the acoustic driver 30 at discrete frequencies within a frequency range of interest that spans a resonance frequency of the resonator 18. For all tests, the sound pressure level was maintained at about 138 dB as measured under steady-state conditions within the resonator 18. The TAR 10 was wrapped in insulating foam during testing to minimize thermal and acoustic flanking paths. The processor 54 may be a data-acquisition device or computing device, for example.

Air under ambient conditions (Pₘ=1 atm, Tₘ=21° C.) is used as the working fluid. Thus, the resonant frequency of a standing wave tube with a closed end can be computed using the relation:

$${f}_{R} = \frac{c}{2 {L}_{R}} .$$

Accounting tor the length, Lₜ, this gives a theoretical fundamental resonance frequency of 114.5 Hz under ambient conditions for the TAR 10, which is suitable to investigate thermoacoustic transduction at relatively low frequencies using additively manufactured (AM) stacks for potential applications related to energy harvesting.

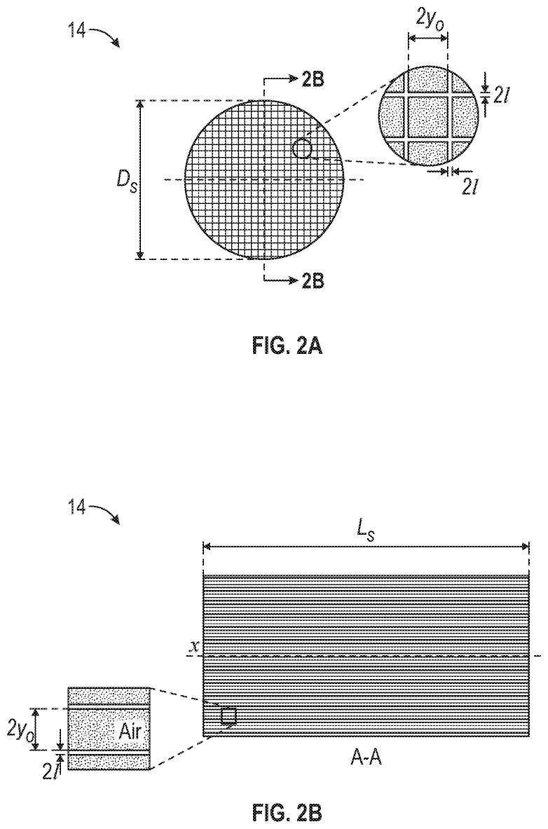

At room temperature and pressure, for given fluid properties, the thermal and viscous penetration depths at the resonance frequency (fᵣ=113 Hz) are calculated to be δₖ=2.5×10⁻⁴ m and δᵥ=2.14×10⁻⁴ m, respectively. As shown in FIGS. 2A-2B, geometric parameters of the porous stack 14 include wall thickness (2l), pore width (2y₀), stack length (Lₛ), and areal porosity (Φ). Areal porosity is defined as a ratio of pore area to total cross-sectional area of the porous stack 14, reflecting a void fraction of the structure of the porous stack 14. For stacks with a square cross-section, the porosity can be calculated using the

$$Φ = \frac{{y}_{0}^{2}}{{( {y}_{0} + l )}^{2}} ,$$

following formula: where yₒ is the half-pore width, and l is the wall thickness. To ensure an effective thermoacoustic cycle, the pore width, (2y₀), may be on the order of two to four times the thermal and viscous penetration depths of the working fluid. Therefore, for the TAR 10 of the first experiment, the width (2y₀) may range from 5.0×10⁻⁴ m to 1.0×10⁻³ m.

As part of the first experiment, multiple embodiments of the porous stack 14 having differing geometric properties were tested, as detailed in the following table:

| | | | | Pore Wall | |
|---|---|---|---|---|---|
| | | | | Thick- | Pore |
| Stack | Length, | Diameter, | Areal | ness, 2l | Width, 2y₀ |
| Properties | lₛ (m) | Dₛ (m) | Porosity, Φ | (10⁻⁴ m) | (10⁻³ m) |
| Stack 12a | 0.170 | 0.097 | 0.80 | 1.01 | 0.860 |
| Stack 12b | 0.178 | 0.0762 | 0.85 | 1.01 | 1.20 |
| Stack 14c | 0.100 | 0.101 | 0.64 | 5.0 | 2.0 |
| Stack 14d | 0.100 | 0.101 | 0.64 | 5.0 | 2.0 |
| Stack 14e | 0.100 | 0.101 | 0.64 | 5.0 | 2.0 |
| Stack 14f | 0.170 | 0.101 | 0.64 | 5.0 | 2.0 |
| Stack 14g | 0.100 | 0.101 | 0.44 | 5.0 | 1.0 |

It should be noted that the stack 12a and the stack 12b are traditional stacks provided for comparison purposes and are commercially sourced stacks. Additionally, material properties of the porous stack 14 also affect performance of thermoacoustic refrigerators and engines. In order to maintain a steady-state temperature gradient along with the porous stack 14, the stack material should have a higher heat capacity than the working fluid. The heat capacity of the stack material should be higher than that of the working fluid to effectively sustain the thermoacoustic phenomenon. While no specific threshold is consistently reported in the literature, it is generally agreed that higher heat capacities improve performance by enhancing thermal coupling. Theoretically, the thermoacoustic phenomenon can be observed as long as the stack material's heat capacity is greater than the working fluid's. However, based on reported studies, a heat capacity of at least 1.5 times greater is recommended for optimal performance. In the present case, the stack material's heat capacity is two times higher, aligning well with these recommendations to ensure efficient operation. An optimal thermal conductivity may also establish a temperature gradient along the axial direction of the porous stack 14. A pore wall thickness (2l) for the stack should be as small as possible while maintaining the stack's ability to withstand acoustic impedance and external forces thereby enabling creation of a higher areal porosity. Stacks with thicker pore walls also tend to create eddies at corners, which contribute to a dissipative loss.

The material properties of the multiple embodiments of the stacks 14 that were tested are listed in the table below:

| | | Thermal | Specific | Melting | | Young's | Thermal Expansion |
|---|---|---|---|---|---|---|---|
| | | Conductivity | Heat | Point | Density | Modulus | Coefficient |
| Stack | Material | (W/(m · K)) | (J/(kg · K)) | (°C) | (kg/m³) | (GPa) | (×10⁻⁶ K⁻¹) |
| Stack 12a | Ceramic | >1.5 | 352 | >2000 | 2000-6000 | >200 | 6-8 |
| Stack 12b | | | | | | | |
| Stack 14c | PLA | 0.13 | 1800 | 173 | 1240 | 3.5 | 23.76 |
| Stack 14g | | | | | | | |
| Stack 14f | | | | | | | |
| Stack 14e | ASA | 0.175 | 1300 | 135 | 1050 | 2.2 | 8.63 |
| Stack 14d | Resin | 0.2 | 1000-1300 | 176 | 1250 | 2.7 | 8.93 |

The ceramic stacks (stacks 12a, 12b) were sourced commercially from Corning's Celcor® line of filters and substrates, which are commonly used as conventional stacks for thermoacoustic devices. These are manufactured through an extrusion process and can be obtained with different combinations of lengths, diameters, and pore geometry. Two ceramic substrates of lengths around 0.17 m and areal porosity of about 0.8 were chosen to act as baseline stacks for comparison purposes.

For the stacks 14c-g, polymeric materials and additive manufacturing processes are considered. Three materials-Polylactic Acid (PLA), Formlabs® standard resin, and Acrylonitrile Styrene Acrylate (ASA) are considered. The properties for the stacks 12a-b are estimated whereas the properties for the stacks 14c-g are specified by the respective manufacturers of the polymeric material.

The stacks 14c, and 14e-g were fabricated using a Fused Deposition Modeling (FDM) process, and the porous stack 14d was fabricated using a stereolithographic (SLA) process. The lengths and porosity of the stacks 14c-g were chosen as detailed above to investigate the influence of these parameters. It is noted that while the chosen fabrication processes are affordable, these processes also impose restrictions on the geometry and size of the pore structure that can be fabricated. The stacks 14 of the first experiment have square pores as shown in FIG. 2A (however, alternative pore cross-sectional shapes are additionally disclosed herein).

Experimental results of the first experiment of the multiple embodiments of the stacks 14 are summarized as test cases in the table below. The test cases evaluated the influence of parameters such as time to steady-state, acoustic excitation frequency, stack length, porosity, material, and position. For each test case, the base parametric setting, [Pₘ, Tₘ, P₁]=[1 atm, 21° C., 138 dB] is preserved. Except for the stack position variation cases, all other cases have a stack position, xₛ=0.1 m (measured from the aperture 26 of the TAR 10. Multiple trials are considered for various test cases, and in each test case, the first and second temperatures are recorded for discrete excitation frequencies spanning the frequency range of interest (80-140 Hz).

| Test Case # | Parameter | Values/Type | Stacks | Measurements |
|---|---|---|---|---|
| t1-t4 | Time to steady- | t ∈ [0, 45] min | Stacks 12a, 14e, | T_{c}, Tₕ, P₁, t, f |
| | state | | 14d, 14f | |
| f1-f7 | Excitation | f ∈ [80, 140] Hz | Stacks 12a-12b, | T_{c}, Tₕ, P₁, f |
| | frequency | | 14c-g | |
| L1, L2 | Stack length | Lₛ = [0.1, 0.17] m | Stacks 14c, 14e | T_{c}, Tₕ, P₁, f |
| Φ₁, Φ₂ | Stack porosity | Φ = [0.64, 0.44] | Stack 14c, 14d | T_{c}, Tₕ, P₁, f |
| M1-M5 | Stack material | Ceramic, PLA, ASA, | Stacks 12a, 14c, | T_{c}, Tₕ, P₁, f |
| | | Resin | 14e, 14f, 14g | |
| x1-x7 | Stack position | xₛ = [0.1, 0.2, 0.3] m | Stacks 12a-12b, | T_{c}, Tₕ, P₁, fₒ |
| | | | 14c-g | |

In the first experiment, the time required to achieve a nearly steady-state condition depended on various factors, including the operating conditions and the geometrical configuration of the resonator 18. As the excitation frequency nears the resonance frequency of the resonator 18, the temperature difference between the first side 40 and the second side 44 reaches a maximum. Generally, convergence to steady-state is found to be faster for the second side 44 compared to the first side 40. In all cases, a nearly steady-state temperature gradient was established in about 20-25 minutes. For purposes of the tests, a temperature rise of 0.1 deg C./min was considered to be steady state.

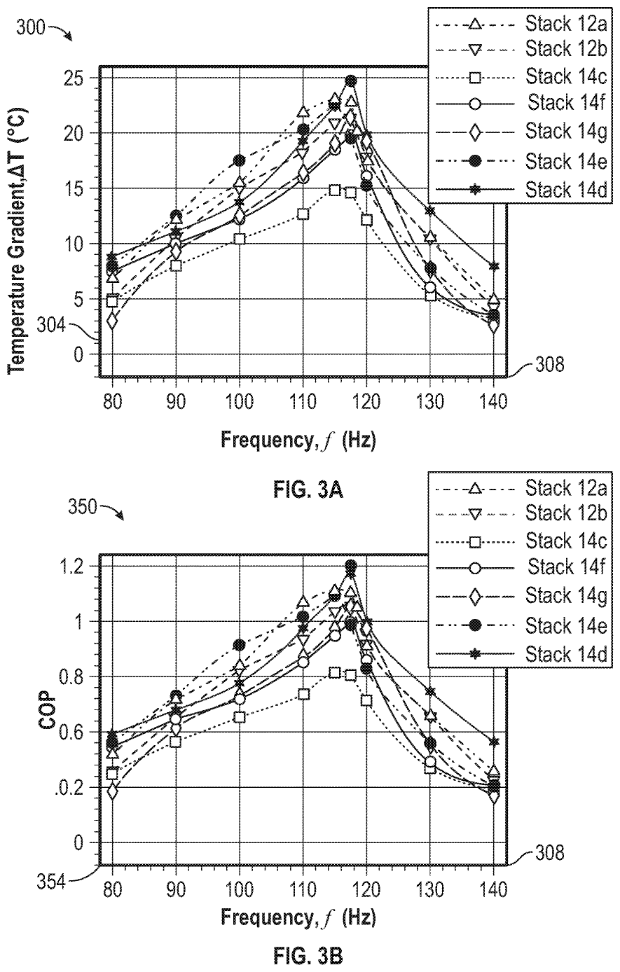

Referring now to FIG. 3A, shown therein is an exemplary embodiment of a temperature gradient graph 300 in accordance with the first experiment. The temperature gradient graph 300 shows a steady-state temperature difference 304 between the first side 40 and the second side 44 (ΔT) for each porous stack 14 versus an excitation frequency 308, f. For each porous stack 14 in the first experiment, the stack position was retained at 0.1 m from the aperture 26. The temperature difference peaks in the frequency range of 110-120 Hz, with a highest value occurring at around 115 to 117.5 Hz, corresponding with the theoretically computed resonance frequency for the TAR 10 of 113 Hz, as detailed above. In general, the stacks 14c-g stacks have comparable or better performance than the stacks 12a-b. Generally, a maximum error for measurement of the temperature difference is 15% near the resonance frequency (although errors for most data points are significantly smaller than 15%.

Referring now to FIG. 3B, shown therein is an exemplary embodiment of a coefficient of performance (COP) graph 350 in accordance with the first experiment. The COP graph 350 shows a COP 354 for each porous stack 14 versus the excitation frequency 308, f. For each porous stack 14 in the first experiment, the stack position was retained at 0.1 m from the aperture 26. It should be understood that for thermoacoustic devices, where the thermoacoustic device operates by converting acoustic energy into a thermal gradient, direct application of the Carnot Coefficient of Performance formula may not adequately describe the thermoacoustic device's behavior. Therefore, as used herein, the COP may be defined as:

$$COP = \frac{\vert {T}_{h} - {T}_{a} \vert + \vert {T}_{a} - {T}_{c} \vert}{{T}_{a}} = \frac{\vert {T}_{h} - {T}_{c} \vert}{{T}_{a}} ,$$

wherein the thermoacoustic device transitions from room temperature, Tₐ, to generate the first temperature, Tₕ, (e.g., a hot-side temperature) and the second temperature, T_{c} (e.g., a cold-side temperature). The above COP formula represents a combined effect of the temperature changes on both the first side and the second side relative to the ambient/room temperature, thus aligning the thermoacoustic device's performance evaluation with operational characteristics.

As shown in FIGS. 3A-3B, the ceramic stacks (i.e., stack 12a and stack 12b) have higher porosity than the stacks 14c-g. Among the stacks 14c-g, the porous stack 14d (constructed of resin) and the porous stack 14e (constructed of ASA) perform better than the stacks 14c, f-g (constructed of PLA). Although the resin stack (e.g., porous stack 14d) is neither the longest nor does it have optimal geometric parameters for the pores, the porous stack 14d achieved the maximum temperature difference (ΔT=24.8° C.) and corresponding maximum COP (1.2) at an excitation frequency of 117.5 Hz. However, it was observed that the surface finish of the porous stack 14d appeared to be most consistent among all the stacks 14, potentially minimizing dissipative effects on the acoustic signal. Overall, the stacks 14c-g are shown to potentially deliver a same or better performance compared with conventional ceramic stacks (i.e., stacks 12a-b) while being more affordable, lightweight, and amenable to more complex geometries, thereby improving the power-to-volume ratio of thermoacoustic devices incorporating the stacks 14c-g.

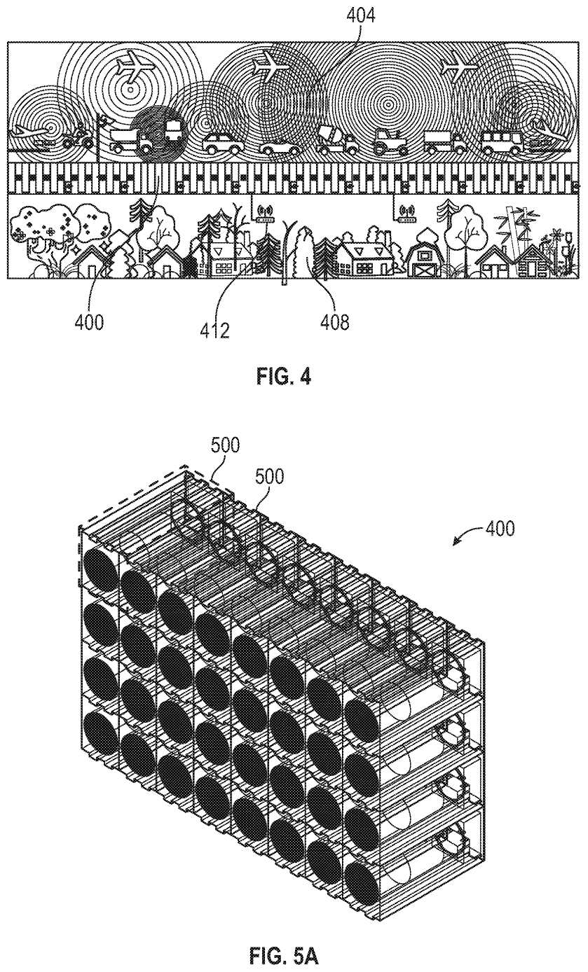

Referring now to FIG. 4, shown therein is an illustration of an exemplary embodiment of a thermoacoustic metastructure barrier 400 (hereinafter TAMS barrier 400) designed to be used in accordance with the present disclosure. As shown in FIG. 4, the TAMS barrier 400 may be disposed between an acoustically-intense environment 404 and a sound-protection region 408. In one embodiment, the TAMS barrier 400 may be constructed as a barrier (e.g., wall) disposed between the acoustically-intense environment 404 and the sound-protection region 408.

In one embodiment, the acoustically-intense environment 404 may be an environment that generates excess noise or noise pollution. Exemplary acoustically-intense environments 404 may include, for example, highways, airports, and industrial facilities.

In one embodiment, the sound-protection region 408 may be a region that desires to have reduced sound pollution or other reduced acoustic interference. For example, the sound-protection region 408 may be a residential neighborhood, or, in some embodiments, may be a particular building or campus desiring reduced extraneous noise, such as a school building or a school campus, for example. In some embodiments, the sound-protection region 408 may be a nature preserve wherein, for example, the TAMS barrier 400 reduces human-generated noise from interfering with wildlife.

In one embodiment, the TAMS barrier 400 may be coupled to one or more power sink 412. The one or more power sink 412 may be an electrical energy storage device, such as a battery, and/or any electronic device requiring electrical power and may include, for example, distributed energy storage to power low-power electronics. For example, the one or more power sink 412 may include environmental surveillance systems, such as cameras, wireless communications systems and/or repeaters, remote sensors, and/or the like.

In this way, the TAMS barrier 400 may utilize the acoustic energy generated by various noise sources for energy harvesting and monitoring purposes. Hence, the TAMS barrier 400 serves a dual purpose of reducing noise and being a renewable energy source and an environmental monitoring station. Therefore, the TAMS barrier 400 may be also well-suited for applications in remote or harsh environments to enable energy harvesting to power remote sensing and monitoring systems.

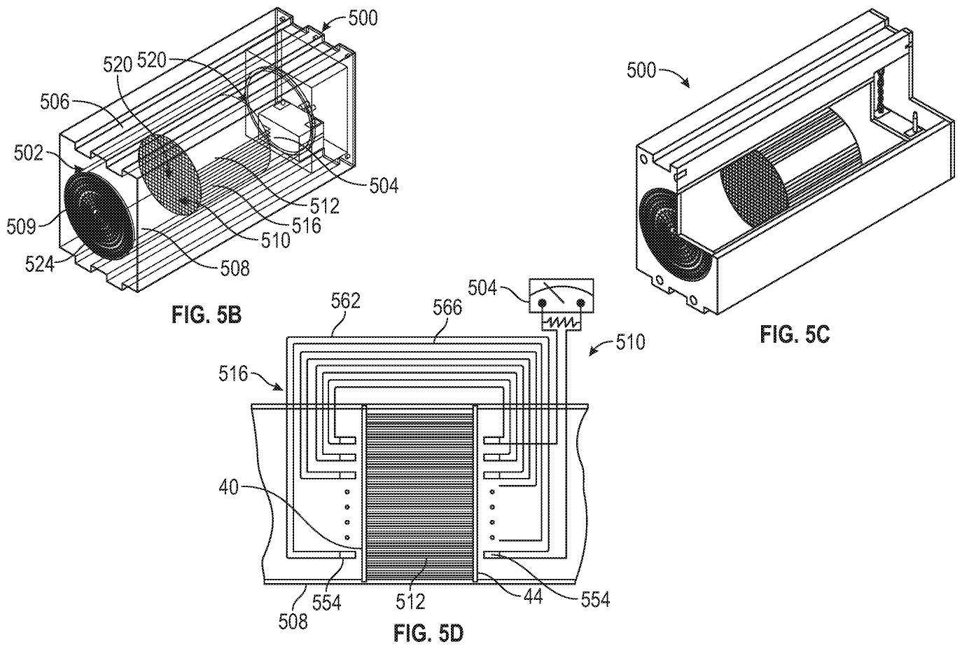

Referring now to FIGS. 5A-5C, in combination, shown in FIG. 5A is a diagram of an exemplary embodiment of the TAMS barrier 400 of FIG. 4, constructed in accordance with the present disclosure. The TAMS barrier 400 may be constructed as an infrastructural barrier having a plurality of modular cells 500 (singularly, modular cells 500 and plurally modular cells 500) comprising a thermoacoustic metastructure 502 (hereinafter TAMS 502) coupled to power circuitry 504 and supported by a modular housing 506.

As shown in FIG. 5B, the TAMS 502 generally comprises a resonator 508 and a thermoacoustic stack 510. The modular cells 500 may be arranged to form a barrier to acoustically separate the acoustically-intense environment 404 and the sound-protection region 408 or to mitigate acoustic impacts of the acoustically-intense environment 404 on the sound-protection region 408 as the TAMS barrier 400 (FIG. 4). In this way, the TAMS barrier 400 would have a high power-to-volume ratio, be rugged, be easy to fabricate, and be cost-effective. In some embodiments, the modular cells 500 may be interlocked with one another to form the infrastructural barrier, i.e., the TAMS barrier 400.

Referring now to FIGS. 5B and 5C, in combination, shown in FIG. 5B is a transparent perspective view of an exemplary embodiment of a modular cell 500 of the TAMS barrier 400 and shown in FIG. 5C is a cut-away perspective view of the modular cell 500, constructed in accordance with the present disclosure. The modular cell 500 may be a tunable unit cell comprising the TAMS 502 and the power circuitry 504, both supported by the modular housing 506. The TAMS 502 may comprise the resonator 508 having an opening 509, the thermoacoustic stack 510 having a porous stack 512, a thermopile 516 (descried in more detail below in reference to FIG. 5D) and heat exchangers 520. In one embodiment, one or more of the TAMS 502 and the modular cell 500 further comprise a perforated face-sheet 524 disposed over the opening 509 of the resonator 508. The porous stack 512 may be constructed in accordance with one or more of the stacks 14 described herein. In one embodiment, multiples of the TAMS 502 may be electrically coupled to the power circuitry 504 in a parallel or serial manner, such that electrical energy generated by multiple TAMS 502 are received by the power circuitry 504. In one embodiment, the TAMS barrier 400 may comprise a first plurality of modular cells 500 having TAMS 502 electrically coupled to a first power circuitry 504 and a second plurality of modular cells 500 having TAMS 502 electrically coupled to a second power circuitry 504.

It should be understood that the TAMS barrier 400, comprising the modular cells 500 may include modular cells 500 having the same or different TAMS 502. For example, a first modular cell 500 may have a first TAMS 502 comprising a first porous stack 512 (e.g., the porous stack 14c), while a second modular cell 500 may have a second TAMS 502 comprising a second porous stack 512 (e.g., the porous stack 14d). In this way, the TAMS barrier 400 may be constructed and optimized with various configurations of porous stacks 512 to mitigate and/or harvest a broad range of acoustic energy along the TAMS barrier 400. By way of further example, the modular cells 500 in a first segment of the TAMS barrier 400 near highway traffic may be tuned to a first frequency dominant in highway traffic noise while a second segment of the TAMS barrier 400 near an industrial complex may be tuned to a second frequency dominant in the industrial complex noise. In this way, the TAMS barrier 400, having the modular cells 500, may be constructed and optimized for a particular location having particular acoustic concerns.

In one embodiment, the perforated face-sheet 524 may provide for sound wave penetration and structural strength. The resonator 508 may provide for acoustic wave guidance received via the opening 509 and propagating over the working fluid.

In one embodiment, the modular housing 506 may enable the modular cells 500 to be interlocked with one another to form the TAMS barrier 400 in a scalable manner. The thermopile 516, described in more detail below in reference to FIG. 5D, may convert thermal gradients into electricity. The heat exchangers 520 may homogenize temperature on respective sides of the porous stack 512 to optimize the thermal gradient across the porous stack 512.

In one embodiment, as sound waves traverse the porous stack 512, a phase difference between pressure and velocity oscillations arises, establishing the thermal gradient utilized for energy extraction. With the resonator 508 and the TAMS 502 tuned to dominant noise frequencies, the TAMS barrier 400 may further incorporate supplementary absorbers, such as foams, to augment noise dampening properties of the TAMS barrier 400 for acoustic signals outside the dominant noise frequencies.

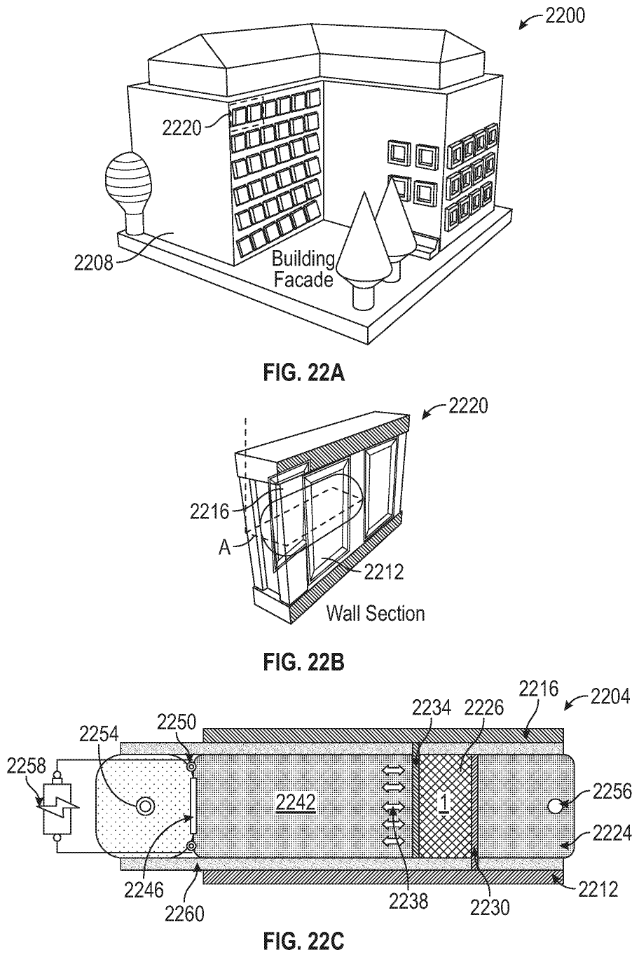

In one embodiment, the power circuitry 504 includes a battery system, such as a battery management system and a rechargeable battery, wherein the power circuitry 504 receives the electrical energy generated by the TAMS barrier 400. The generated energy, received by the power circuitry 504, may thus be used to power embedded sensors, monitoring tools, in-situ electronic devices (e.g., electronic devices in the same environment as the TAMS barrier 400, or the TAMS 502), and/or the like. In some embodiment, the sensors and monitoring tools may include the microphones 34, ambient environmental temperature sensors, video recorders, environmental sensors, such as wind speed sensors, rain sensors, light sensors, and/or the like, which may provide diagnostic information of the environment of, surrounding, or near the TAMS barrier 400. The TAMS barrier 400 may further interpret the harvested signal (e.g., received acoustic signal), to provide insights into the surrounding acoustic environment. In-situ electronic devices may include electronic devices located in on or near the TAMS barrier 400. For example, if the TAMS barrier 400 is a highway barrier, then the in-situ electronic devices may include traffic cameras on the highway. Further examples if in-situ electronic devices may include a Wi-Fi router/access point at an airport, traffic lights, lighting such as safety and security lighting, and/or the like. The diagnostic information may be obtained regarding: traffic, weather/wind, building HVAC load patterns (e.g., as described in FIGS. 22A-22C), ambient noise, a soundscape (e.g., used to determine a noise pollution), and/or the like, or combinations thereof.

Referring now to FIG. 5D, shown therein is a circuit diagram of an exemplary embodiment of the thermopile 516, constructed in accordance with the present disclosure. The thermopile 516 generally comprises an array of thermoelectric transducers 554 connected in series and alternating between a first side 40 (e.g., first location) and a second side 44 (e.g., second location) of the porous stack 512. The thermoelectric transducers 554 can be electrically coupled in either series or parallel configurations, or even a combination of series and parallel, depending on a desired output. In the present setup, the thermoelectric transducers 554 are connected in series to maximize the voltage output. A parallel connection, on the other hand, would maximize the current gain. In practical applications, both series and parallel connections can be combined to achieve the required balance of voltage and current for specific operational needs. The transducers 554 are alternatingly coupled in the described setup to maximize the temperature gradient across the porous stack 512 and optimize the electrical energy generation through the Seebeck effect. This arrangement ensures that the thermoelectric transducers 554 capture the thermal differences between the hot and cold sides effectively. Other arrangements, such as parallel or series-only configurations, may also be used.

In some embodiments, the thermopile 516 comprises between 300 and 500 thermoelectric transducers. The array of thermoelectric transducers 554 may be electrically coupled to the power circuitry 504. Each thermoelectric transducer 554 of the array may be electrically coupled to two wires, each wire exclusively having a first wire type 562 and a second wire type 566, except for a first and last thermoelectric transducer of the array, which are connected to one of the first wire type 562 and the second wire type 566 and to the power circuitry 504. In one embodiment, the thermoelectric transducers 554 are thermocouples. In one embodiment, a number of thermoelectric transducers 554 may be incorporated into the thermopile 516 based on a desired temperature gradient and considering an amount to which the included thermoelectric transducers 554 obstruct the porous stack 512.

In some embodiments, the power circuitry 504 is the processor 54 operating as a data-acquisitions device.

During operation, the thermopile 516 can generate electrical output from temperature differences across the porous stack 512, such as between the first side 40 and the second side 44 by taking advantage of the Seebeck effect, where a temperature gradient generates an electrical voltage across the thermoelectric transducers 554, creating a flow of electrons, thereby providing a clean and renewable source of energy through the conversion of heat to electricity. A Seebeck coefficient may measure a voltage generated per degree of temperature gradient of a material.

In one embodiment, each of the first wire type 562 may be constructed of a first electrically conductive material (first material) while the second wire type 566 may be constructed of a second electrically conductive material (second material) different from the first material. The first and second materials may be selected based on a difference between the Seebeck coefficient in order to optimize the thermopile 550 for a specific temperature range over which to harvest energy. Nichrome and Constantan are commonly used for the first material and the second material, but other alloy combinations may be used.

In one embodiment, the first wire type 562 may be constructed with the first material being a constantan wire (having a Seebeck coefficient of −35 μV/K) while the second wire type 566 may be constructed with the second material being a nichrome wire (having a Seebeck coefficient of 25 μV/K). In some embodiments, a thermally-conductive but electrically-non-conductive epoxy resin (such as OMEGABOND® 101 and 102) may be used to weld the bimetallic junctions in a parallel and/or series configuration as shown in FIG. 5D.

In one embodiment, the theoretical voltage generated due to a temperature gradient, ΔT=Tₕ−T_{c} between the first side 40 (i.e., hot side) and the second side 44 (i.e., cold side) of the porous stack 512 can be obtained as: V=NS_{NC}ΔT=N(S_{N}−S_{C})(Tₕ−T_{c}), where V is the generated voltage, N is the total number of thermoelectric transducers 554, SNC is the Seebeck coefficient difference between the n-type and p-type thermoelectric materials of the wires, Sy is the Seebeck coefficient of nichrome, and S_{C} is the Seebeck coefficient of constantan.

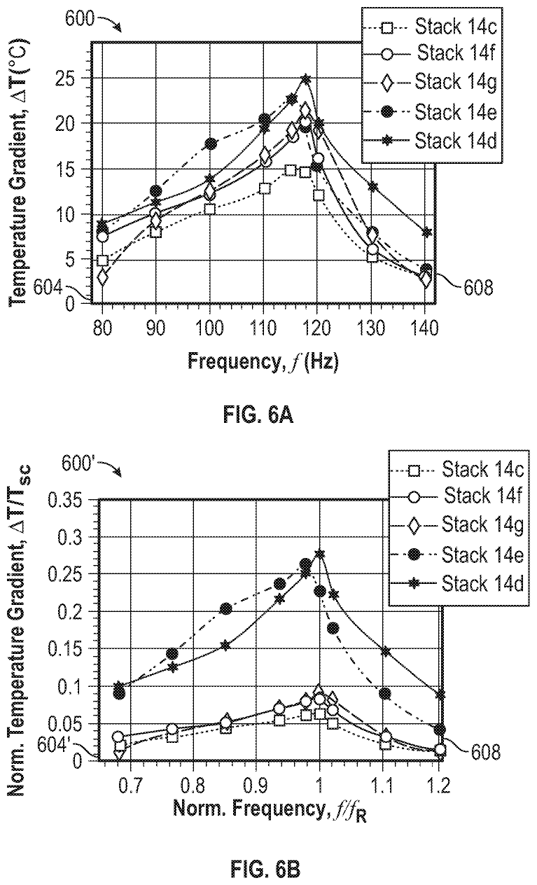

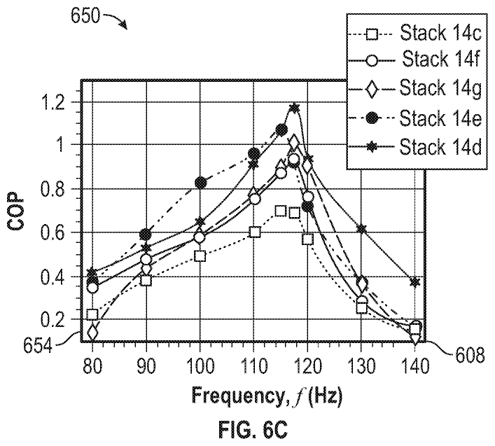

Referring now to FIGS. 6A-6B in combination, shown therein is an exemplary embodiment of a temperature gradient graph 600 and a normalized temperature gradient graph 600′ in accordance with a second experiment. The temperature gradient graph 600 shows a steady-state temperature difference 604 between the first side 40 and the second side 44 (ΔT) for stacks 14c-g versus an excitation frequency 608, f. For each porous stack 14c-g in the second experiment, the stack position, xₛ, was retained at 0.1 m from the aperture 26 of the resonator 18 in the TAR 10 (FIG. 1).

The temperature gradient was normalized for the normalized temperature gradient graph 600′ using a characteristic temperature factor T_{sc}, where:

$$Δ {T}_{n} = \frac{Δ T}{{T}_{s c}} , and {T}_{s c} = \frac{ρ \cdot {c}_{p} \cdot A \cdot {f}_{R}}{k \cdot β} \cdot {10}^{- 9} ,$$

where, k represents the thermal conductivity, β is the coefficient of linear thermal expansion, ρ is the density, cₚ, is the specific heat capacity, A is the cross-sectional area, and f_{R} is the resonance frequency. The results of the second experiment indicate that a normalized temperature gradient 604′ exhibits a peak within a frequency range of 110-120 Hz, with the highest value achieved at 115 or 117.5 Hz. This observation aligns with the theoretically predicted resonance frequency for the TAR 10, which is 113 Hz. It was noted that the ASA and resin stacks (i.e., stacks 14d-e) exhibited improved performance in comparison to the PLA stacks (i.e., stacks c, f-g). It is believed that this performance difference may be attributed to a higher characteristic temperature T_{sc} of ASA and resin materials, which suggests that these materials have favorable thermal properties such as higher specific heat capacity and density, coupled with moderate thermal conductivity and thermal expansion.

Referring now to FIG. 6C, shown therein is an exemplary embodiment of a coefficient of performance (COP) graph 650 in accordance with the second experiment. The COP graph 650 shows a COP 654 for each porous stack 14c-g versus the excitation frequency 608, f. For each porous stack 14c-g in the second experiment, the stack position was retained at 0.1 m from the aperture 26 of the resonator 18 in the TAR 10 (FIG. 1). Despite the resin stack (e.g., porous stack 14d) not having the longest length or optimal geometric parameters for its pores, the porous stack 14d achieved the highest temperature gradient of 24.8° C. and corresponding with a maximum COP of 1.16 at an excitation frequency of 117.5 Hz. It was also observed that the surface finish of the resin stack (e.g., porous stack 14d) appeared to be the most favorable among all the stacks 14c-g, potentially reducing dissipative effects.

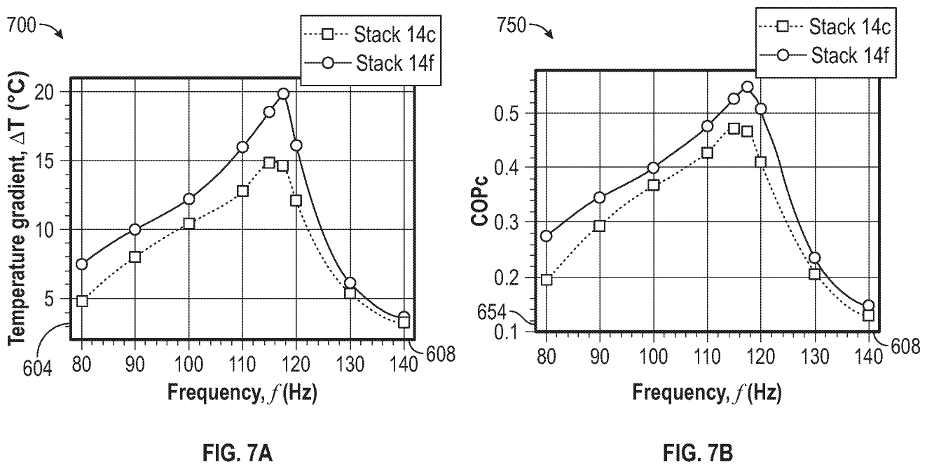

Referring now to FIG. 7A, shown therein is an exemplary embodiment of a temperature gradient graph 700 for stacks of varying lengths, and to FIG. 7B, shown therein is an exemplary embodiment of a coefficient of performance (COP) graph 750 for stacks of varying lengths, in accordance with the second experiment. The temperature gradient graph 700 is similar to the temperature gradient graph 600 except that the temperature gradient graph 700 only shows the temperature gradient for the porous stack 14c and the porous stack 14f. Similarly, the COP graph 750 is similar to the COP graph 650 except that the COP graph 750 only shows the COP for the porous stack 14c and the porous stack 14f.

Stack length plays a significant role in the performance of a thermoacoustic device. An increase in stack length results in a larger surface area, thereby facilitating greater temperature drops. However, as the stack length increases, the level of dissipative loss also increases, ultimately impacting performance of the thermoacoustic device. In some embodiments, the stack length may be maintained in a range from 1/15 to 1/25 of the excitation wavelength. FIGS. 7A-7B illustrate performance of two variants of a PLA stack with varying lengths (0.1 m, i.e., porous stack 14c, and 0.17 m, i.e., porous stack 14f), but with identical porosity. The longer stack (e.g., porous stack 14f) exhibits increased performance across the entire frequency range 608, with a 40% enhancement in temperature gradient 604 near the resonance frequency if about 115 Hz. A longer stack length reduces heat conductance through the walls of the stack, thereby establishing a greater temperature gradient when dissipative effects are minimal.

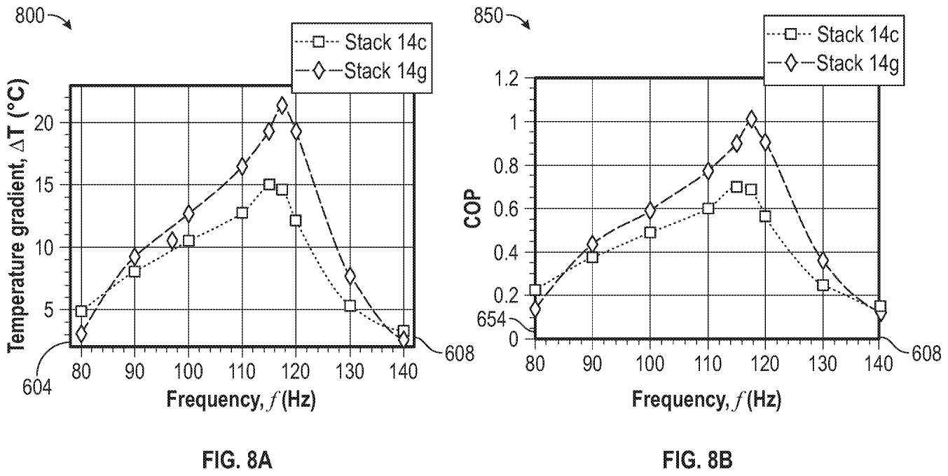

Referring now to FIG. 8A, shown therein is an exemplary embodiment of a temperature gradient graph 800 for stacks of varying porosity, and to FIG. 8B, shown therein is an exemplary embodiment of a coefficient of performance (COP) graph 850 for stacks of varying porosity, in accordance with the second experiment. The temperature gradient graph 800 is similar to the temperature gradient graph 600 except that the temperature gradient graph 800 only shows the temperature gradient for the porous stack 14c and the porous stack 14g. Similarly, the COP graph 850 is similar to the COP graph 650 except that the COP graph 850 only shows the COP for the porous stack 14c and the porous stack 14g.

Porosity of the porous stack 14 is an important geometric factor that may impact performance of thermoacoustic devices. As porosity decreases, there is an increase in viscous losses as the gas parcel travels through the porous stack 14. A substantial decrease in porosity can lead to the TAR system losing its cooling function. In general, a porous stack 14 with higher porosity is more desirable as more openings may be provided for fluid to pass through, resulting in less viscous losses. To increase the porosity of a stack, various methods can be employed, such as increasing the pore width or decreasing the pore wall thickness (shown in FIGS. 2A-2B). In additive manufacturing, the minimum wall thickness that can be achieved is contingent upon the printer's material, process, and specifications. However, working with dimensions close to the minimum thickness can result in poor tolerance and finish. Therefore, the wall thickness and the pore width may be selected to change the porosity based on the printing characteristics of the additive manufacturing device used.

An optimum pore width of a porous stack 14 is determined by determining a thermal penetration depth of the fluid for a given temperature and pressure. For example, at a resonance frequency of 117.5 Hz, the thermal penetration depth for air at room temperature is 2.42×10⁻⁴ m. Therefore, the optimum pore width would be approximately 1×10⁻³ m. Stack porosity can be adjusted by modifying the pore width or wall thickness. However, the optimum pore width is dependent on the thermal penetration depth of the fluid and should be taken into consideration during the design process.

FIGS. 8A-8B present a comparative analysis of the performance of two polylactic acid (PLA) stacks (e.g., stacks 14c and 14g) with varying porosities. The porous stack 14 with a porosity of 44% (e.g., porous stack 14g) exhibits an approximate 50% increase in resonance temperature gradient in comparison to the stack with a porosity of 64% (porous stack 14c). It is noteworthy that the lower porosity of the porous stack 14g was achieved through the reduction of pore width while maintaining the same pore wall thickness as that of the porous stack 14c, rather than scaling both the width and wall thickness. As a result, despite the lower porosity of the porous stack 14g, its pore width (1×10⁻³ m) is closer to four times the thermal penetration depth, which may be preferable for stack performance, than that of the porous stack 14c stack (2×10⁻³ m).

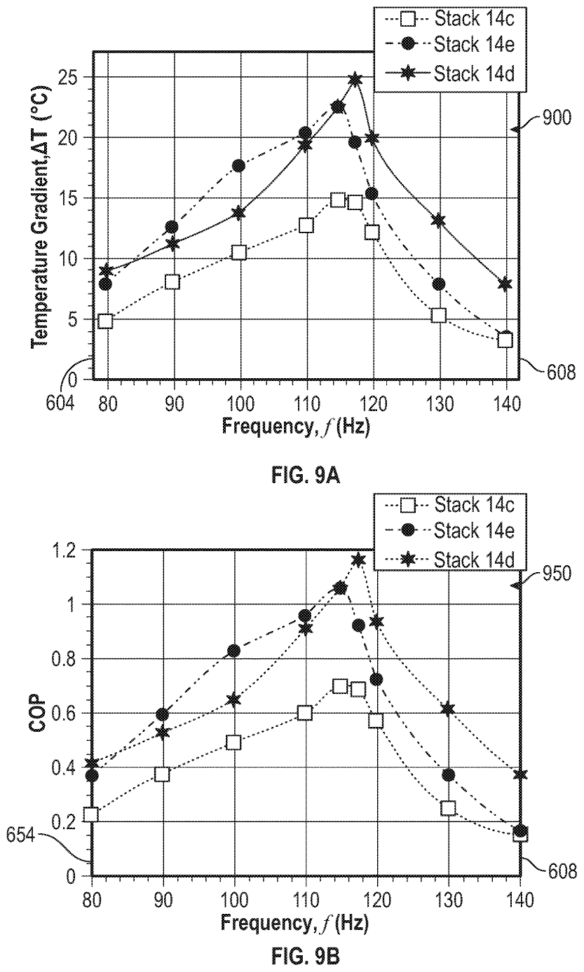

Referring now to FIG. 9A, shown therein is an exemplary embodiment of a temperature gradient graph 900 for stacks of varying thermal conductivity, and to FIG. 9B, shown therein is an exemplary embodiment of a coefficient of performance (COP) graph 950 for stacks of varying thermal conductivity, in accordance with the second experiment. The temperature gradient graph 900 is similar to the temperature gradient graph 600 except that the temperature gradient graph 900 only shows the temperature gradient for the porous stack 14c, porous stack 14e, and the porous stack 14d. Similarly, the COP graph 950 is similar to the COP graph 650 except that the COP graph 950 only shows the COP for the porous stack 14c, porous stack 14e, and the porous stack 14d.

Thermal conductivity is a material property that plays a role in determining the performance of a porous stack 14. The thermal conductivity of a porous stack 14 is inversely proportional to its effectiveness in counteracting thermoacoustic heat transfer direction. In addition to thermal conductivity, the specific heat capacity of the porous stack 14 is also a significant factor that must be taken into consideration. To effectively extract useful work from acoustic waves through thermoacoustics, a porous stack 14 with a high specific heat capacity and large surface area in contact with the gas parcel is ideal as it enables efficient heat exchange without significant changes in the Temperature of the gas parcel.

FIGS. 9A-B present a comparative analysis of the performance of three stacks, all of which were fabricated with the same length and porosity, using PLA (e.g., porous stack 14c), ASA (e.g., porous stack 14e), and resin (e.g., porous stack 14d) as the materials. The results indicate that among the stacks fabricated using additive manufacturing techniques, the porous stack 14d (resin stack) exhibited the best performance. The performance of the porous stack 14e (ASA stack) was similar to that of the porous stack 14d below the resonance frequency, however, performance of the porous stack 14e dropped below that of the porous stack 14d at and above the resonance frequency. The performance of the porous stack 14c (PLA stack) was significantly lower in comparison to the other two stacks 14d-e. The improved performance of the porous stack 14d can be partly attributed to its better surface finish among the stacks, while the porous stack 14c had relatively poor surface finish that may have contributed to increased dissipative losses.

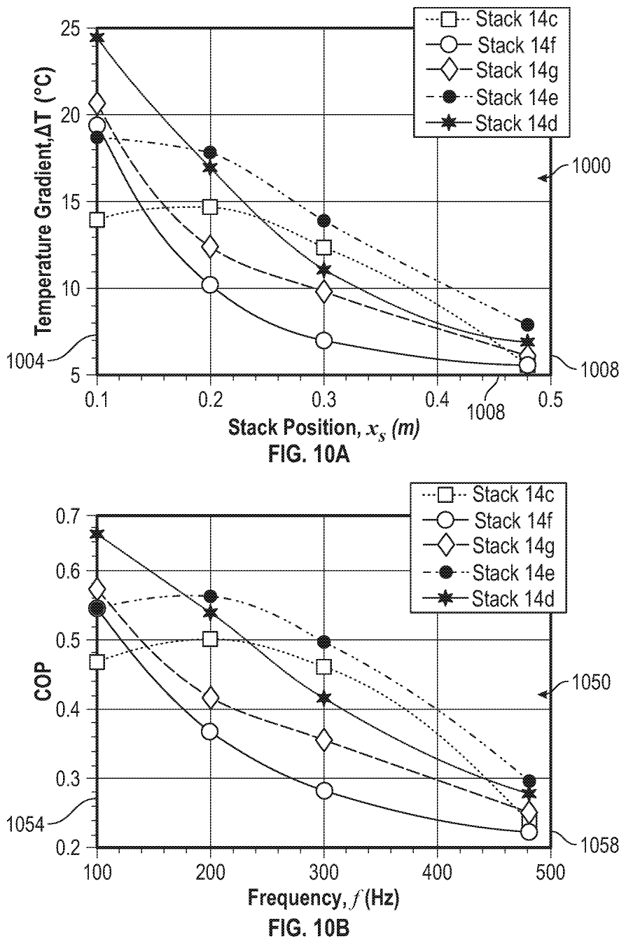

Referring now to FIG. 10A, shown therein is an exemplary embodiment of a temperature gradient graph 1000 for stacks at varying positions, and to FIG. 10B, shown therein is an exemplary embodiment of a coefficient of performance (COP) graph 1050 for stacks at varying positions, in accordance with the second experiment. The temperature gradient graph 1000 shows the temperature gradient 1004 for the stacks 14c-g at various stack positions 1008. The COP graph 1050 shows the COP 1054 for the stacks 14c-g at frequencies 1058 of between 100 Hz and 500 Hz, well beyond the resonance frequency.

As shown, positioning of the porous stack 14 within the resonator tube (e.g., resonator 18) additionally determines performance of a thermoacoustic device. Preferred positioning is influenced by various factors, including the length of the porous stack 14. However, in general, the porous stack 14 has improved performance when the porous stack 14 is positioned closer to the aperture 26 or driver 30 than the end-stop 22, i.e., near a pressure antinode. The location of the pressure antinode can vary depending upon the dimensions of the resonator 18. The temperature gradient 1004 achieved is directly proportional to the pressure amplitude difference between the ends of the porous stack 14.

The dimension of the resonator 18 can also generate interactive effects when the position of the porous stack 14 is altered along the axis of the resonator 18. In a closed-closed-end configuration, the pressure antinodes are located at both ends of the resonator 18 while the velocity antinode is situated at the center. FIGS. 10A-10B illustrate performance of the TAR 10 when the porous stack 14 within the resonator 18 is positioned at 0.1 m, 0.2 m, 0.3 m, and 0.48 m from the acoustic driver 30 or aperture 26. Steady-state temperatures of both sides (the first side 40 and the second side 44) of the stacks 14c-g were recorded at resonance (117.5 Hz) for each case. It was observed that performance drops as the respective porous stack 14 is moved more than 0.1 meters away from the acoustic driver 30 (e.g., the aperture 26). The resin stack (e.g., porous stack 14d) had the highest performance for a stack positioned 0.1 meters away from the acoustic driver 30, and the performance significantly declines (nearly 50%) as the porous stack 14d is moved farther away. However, it is worth noting that placing the porous stack 14 extremely close to the acoustic driver 30 may potentially trigger nonlinear effects, which can generally spread resonant response over a broader frequency range at the expense of peak performance.

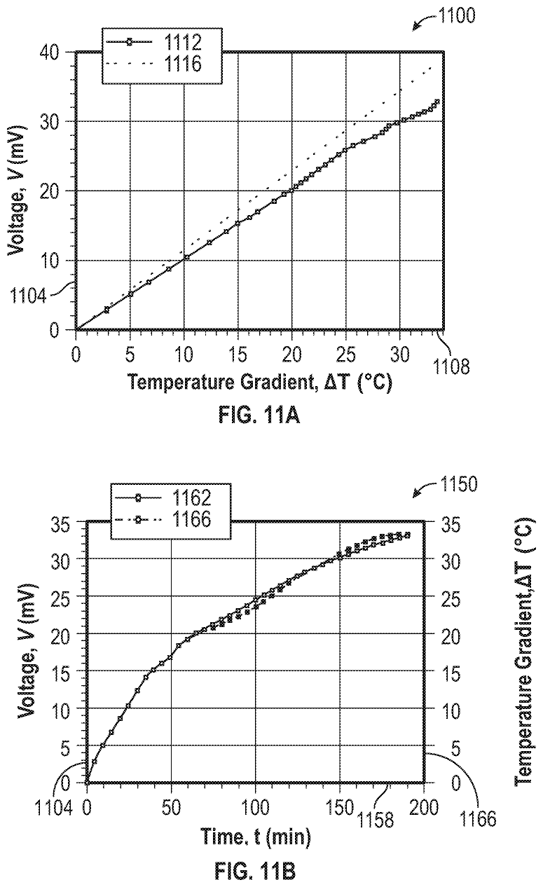

Referring now to FIG. 11A, shown therein is an illustration of an exemplary embodiment of a graph 1100 of experimental vs analytical energy output for the porous stack 14d constructed in accordance with the second experiment. The graph 1100 generally shows a generated voltage 1104 at differing temperature gradients 1108 for experimental data 1112 and analytical data 1116 embodiments of the porous stack 14d (i.e., the resin stack). As illustrated in FIG. 11A, the second experiment the resin stack (i.e., porous stack 14d) achieved a steady-state peak voltage of 33 mV at an acoustic excitation frequency of 117.5 Hz, coinciding with a temperature gradient of 33.5° C. between the hot and cold sides of the stack. The graph 1100 shows a linear relationship between the temperature gradient 1108 (ΔT) and the generated voltage 1104 (V), with the second experimental data 1112 closely following the analytical data 1116 up to a certain point. However, as the temperature gradient 1108 increases, a slight deviation of the analytical data 1116 from the experimental data 1112 is observed, indicating that the voltage output 1104 for the experimental data 1112 is slightly lower than predicted by the analytical data 1116. Despite this discrepancy, the TAR 10 still attains a high energy conversion efficiency of approximately 85% at the maximum output, which demonstrates the effectiveness of the porous stack 14d (resin stack) in converting thermal energy into electrical energy.

Referring now to FIG. 11B, shown therein is an illustration of an exemplary embodiment of a graph 1150 of experimental vs analytical energy output for the porous stack 14d, constructed in accordance with the second experiment. FIG. 11B presents times 1158 of both the generated voltage 1104 and the temperature gradient (ΔT) 1166 as the system progresses towards a steady-state condition. The graph 1150 shows that both the generated voltage 1104 and the temperature gradient 1166 increase steadily over time 1158, with the generated voltage 1104 following a nearly linear trend. The time history suggests that the TAR 10 may take a certain period of time to reach thermal equilibrium, after which the generated voltage 1104 stabilizes at a peak value.

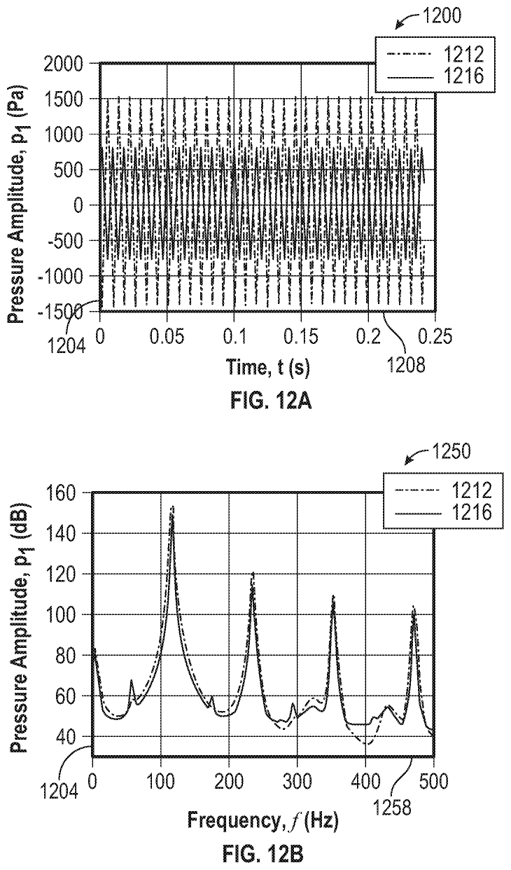

Referring not to FIGS. 12A-12B, in combination, shown therein are graphs of the sound transmission loss across the stack in accordance with the second experiment. FIG. 12A shows a first graph 1200 of pressure amplitude 1204 at various times 1208 measured by the first microphone 34a (on an incident side 1212) and the second microphone 34b (on a transmitted side 1216). FIG. 12B shows a second graph 1250 of pressure amplitude 1204 at various frequencies 1258 measured by the first microphone 34a (incident side) and the second microphone 34b (transmitted side).

Investigating sound transmission loss across the porous stack 14 of the TAR 10 may provide insight into the impact of thermoacoustic conversion on sound pressure level reduction. In order to gather this data, microphones 34 were placed at both the acoustic driver 30 end of the resonator 18 (FIG. 1) and end-stop 22 end of the resonator 18 to record standing wave pressure time histories during thermoacoustic steady-state. The experimental results, as illustrated in FIGS. 12A-12B, present the incident-side 1212 and transmitted-side 1216 microphone signals. These experimental results demonstrate a decrease in Sound Pressure Level (SPL) of approximately 5.28 dB at resonance (117.5 Hz) between the far end and acoustic driver end of the resonator 18. This decrease in noise level can be mostly attributed to presence of a porous stack 14 in the sound path between the sound source and the closed end, also known as insertion loss. A minor part of the decrease in noise level can be attributed to the thermoacoustic energy conversion.

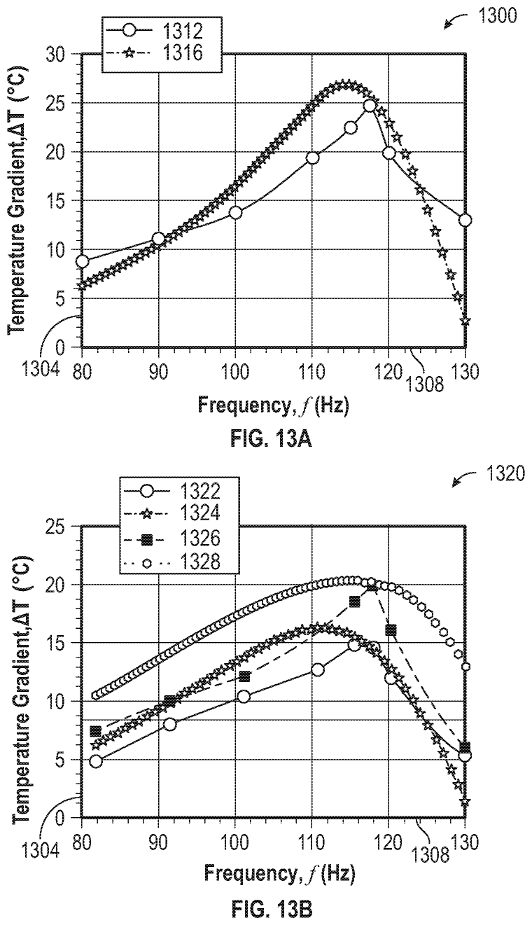

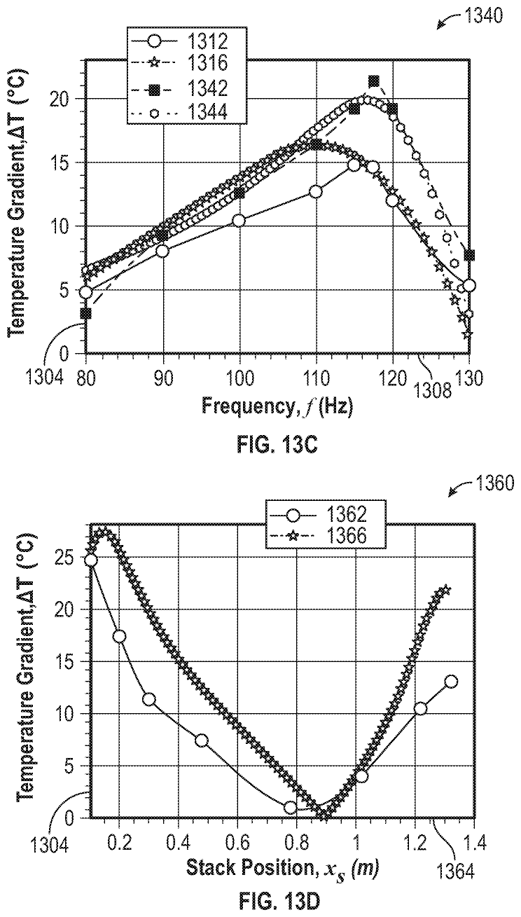

Referring now to FIGS. 13A-13D, shown therein are graphs of exemplary embodiments of comparisons of experimental data and simulation data for combinations of stacks 14 in accordance with the second experiment. The simulation data were generated using DeltaEC, a specialized tool developed for modeling low-amplitude thermoacoustic energy conversion systems. DeltaEC integrates a one-dimensional wave equation within a user-defined geometry, accommodating both acoustic and thermoacoustic elements. DeltaEC was employed to simulate the thermoacoustic performance of the TAR 10, using air as the working fluid under ambient conditions, with thermodynamic properties of Thermal conductivity, k (W/(m·K)) of 0.025, Sound velocity, a(m/s) of 343, Specific heat ratio of air, γ, of 1.4, Heat capacity, C_{P}(J/(kg·K)) of 1004.7, Prandtl number, σ, of 0.70, and Air density ρ, kg/m3 of 1.118. The simulation assumed ideal boundary conditions, with perfect lateral insulation along the resonator 18. Four fundamental initial conditions were established, comprising magnitude and phase of the acoustic pressure (p₁) and magnitude and phase of the volumetric flow rate (U₁). At the terminus of the final segment, infinite acoustic impedance boundary conditions were implemented.

FIG. 13A illustrates a graph 1300 of a temperature gradient 1304 at varying frequencies 1308 for experimental data 1312 of the porous stack 14d and simulated data 1316 of the porous stack 14d. FIG. 13B illustrates a graph 1320 of the temperature gradient 1304 at varying frequencies 1308 for experimental data 1322 of the porous stack 14c, simulated data 1324 of the porous stack 14c, experimental data 1326 of the porous stack 14f, and simulated data 1328 of the porous stack 14f. FIG. 13C illustrates a graph 1340 of the temperature gradient 1304 at varying frequencies 1308 for experimental data 1322 of the porous stack 14c, simulated data 1324 of the porous stack 14c, experimental data 1342 of the porous stack 14g, and simulated data 1344 of the porous stack 14g. FIG. 13D illustrates a graph 1360 of the temperature gradient 1304 at varying stack positions 1364 for experimental data 1362 of the porous stack 14d and simulated data 1366 of the porous stack 14d.

As shown in FIGS. 13A-13C, a trend and peak of the resonance frequency are closely captured by the simulation data, although the simulated temperature gradient is around 10-15% higher than the experimental values. This mismatch is most likely caused by variances in the simulation model and experimental setup including the geometric and thermophysical properties of the stacks 14. Despite this discrepancy, the simulation offers a reliable forecast of the larger temperature gradient attained by the longer stack (e.g., porous stack 14f) in comparison to the shorter stack (e.g., porous stack 14c), as shown in FIG. 13B. This suggests that the simulation can capture the variations in thermal behavior between the two stacks.

The influence of stack porosity on the DeltaEC performance is also well predicted by the simulation, further demonstrating its accuracy in predicting thermoacoustic performance as shown in FIG. 13C. The simulation effectively captures the trend and peak for stack position variation, and the findings show that moving the stack close to the driver end improves thermoacoustic performance as shown in FIG. 13D.

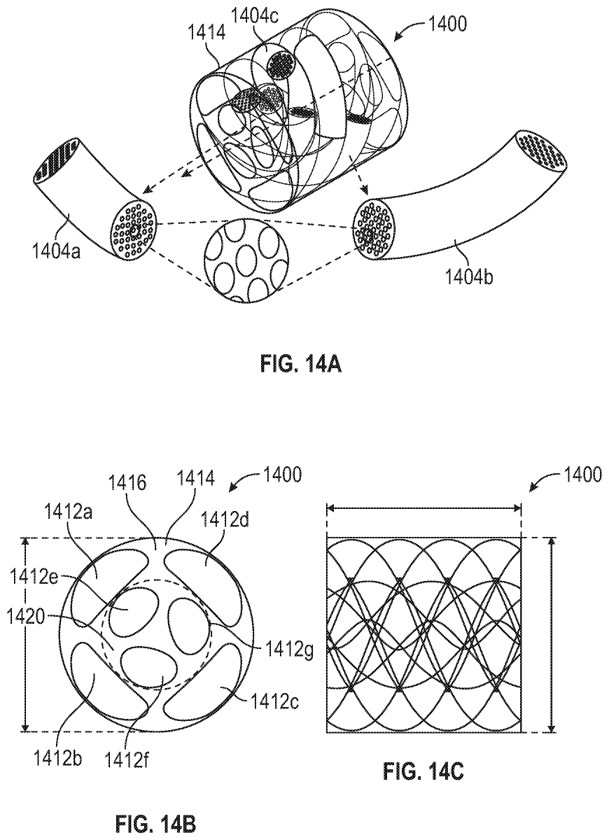

Referring now to FIGS. 14A-14C, in combination, shown in FIG. 14A is a perspective, transparent view of an exemplary embodiment of a spiral resonator 1400 constructed in accordance with the present disclosure. FIG. 14B shows a cross-sectional view of the spiral resonator 1400 across a longitudinal axis, x, of the spiral resonator 1400 while FIG. 14C shows a cross-sectional view of the spiral resonator 1400 along the longitudinal axis, x, of the spiral resonator 1400. The spiral resonator 1400 has a helical design, in contrast with the stacks 14c-g described above in detail. A plurality of spiral stacks 1404 coil within helical openings 1412 of the spiral resonator 1400 defined by the surrounding wall 1414. The helical design of the spiral resonator 1400 results in a more complex interaction with oscillating gas (i.e., working fluid) within the spiral resonator 1400.

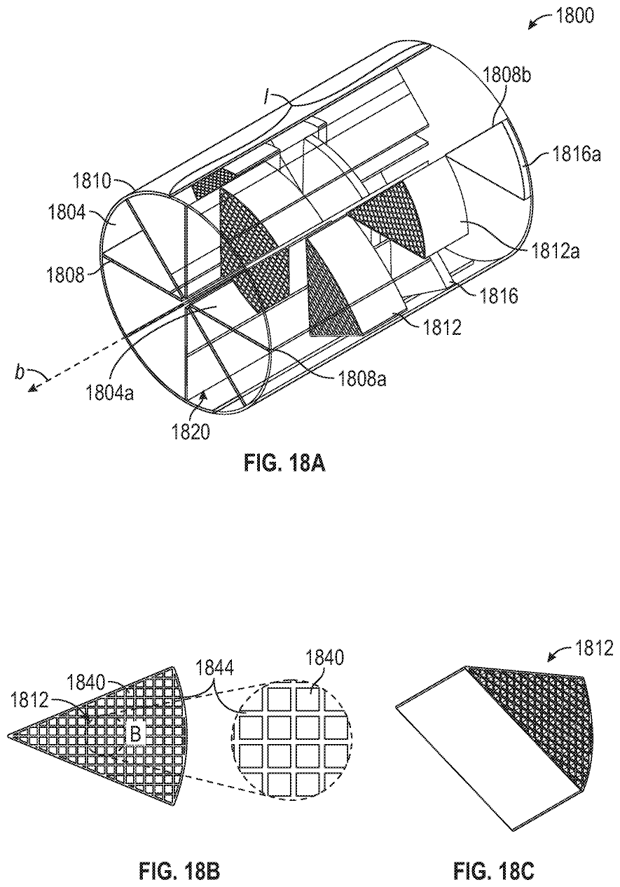

In one embodiment, the helical design of the spiral resonator 1400 enables reinforcing of the thermoacoustic effect—where energy exchange between thermal and acoustic forms is more pronounced and may be more efficient. Each spiral porous stack 1404 may make one complete revolution withing the spiral resonator 1400 and have a diameter measuring about 0.02 m; however, the diameter of each spiral porous stack 1404 may be dependent on a quantity of spiral stacks 1404 within the spiral resonator 1400 and a diameter of the spiral resonator. In one embodiment, the spiral resonator 1400 may be an exemplary embodiment of the resonator 18. In one embodiment, the spiral porous stack 1404 may be an exemplary embodiment of the porous stack 14. As shown in FIG. 14A, the spiral resonator 1400 may comprise seven spiral stacks 1404a-g; however, alternative quantities of the spiral stacks 1404 may be constructed in the spiral resonator 1400. Further, the spiral resonator 1400 may include differing end stops in a manner similar to that shown in FIG. 18A.

In one embodiment, each spiral porous stack 1404 may have a length and diameter similar to that of respective spiral openings 1412. The spiral resonator 1400 may be constructed as compact, extending about 0.1 m in both height and diameter. For example, in a spiral opening 1412 measuring 0.02 m in diameter, the spiral porous stack 1404 may measure 0.025 m in length and 0.02 m in diameter as shown in FIG. 14A. While each spiral porous stack 1404 has a consistent stack linear length, the spiral resonator 1400 achieves different effective lengths due to radial positioning of the spiral stacks 1404. For example, as shown in FIGS. 14A-14C, four spiral openings 1412a-d are positioned in an outer region 1416 of the surrounding wall 1414, while remaining spiral openings 1412e-g are positioned in an inner region 1420 of the surrounding wall 1414.

Although the length of the spiral stacks 1404 inserted into each spiral opening 1412 remains constant, the radial position of each spiral porous stack 1404 is unique, causing variations in effective length along the helical direction for each spiral porous stack 1404. This configuration results in at least two distinct liner length zones within the spiral resonator 1400, creating a dual-frequency domain.

The dual-frequency domain is generated due to outer spiral stacks (spiral stacks 1404a-d) tuned to about 324 Hz and inner spiral stacks (spiral stacks 1404e-g) tuned to about 577 Hz. This unconventional arrangement enables a sweeping coverage of the acoustic spectrum, showcasing an enhanced power-to-volume ratio where lower frequencies are resonated without necessitating a larger structure, thus optimizing spatial efficiency.

In one embodiment, the spiral resonator 1400 may be constructed separately from the spiral stacks 1404, and the spiral resonator 1400 and the spiral stacks 1404 may be constructed of different materials. For example, the spiral resonator 1400 may be constructed using an FDM process and PLA while the spiral stacks 1404 may be constructed using an SLA process and resin.

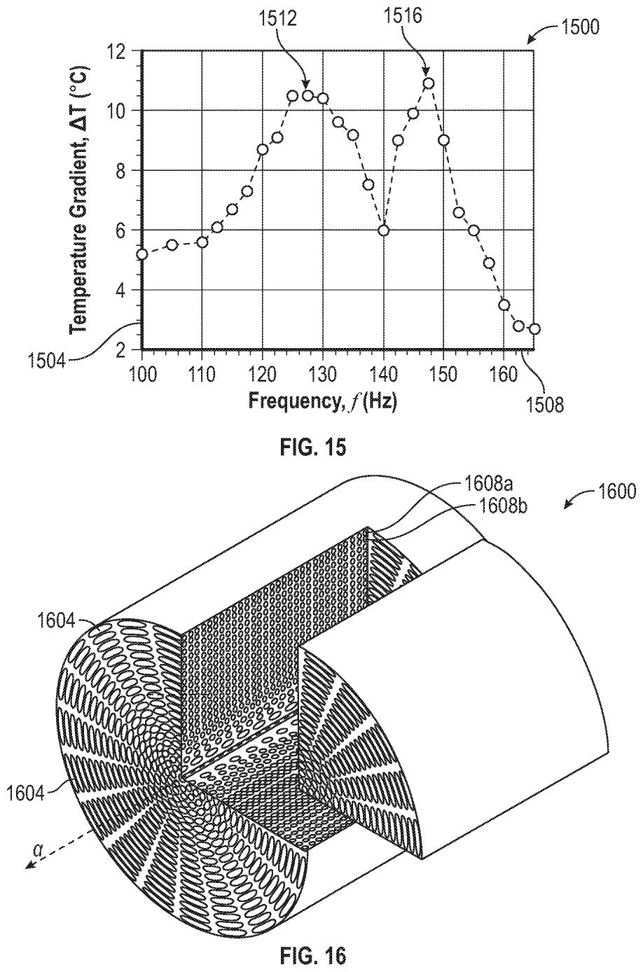

Referring now to FIG. 15, shown therein is an illustration of an exemplary embodiment of a graph 1500 constructed in accordance with the present disclosure and a third experiment. The graph 1500 shows a temperature gradient 1504 at various frequencies 1508 for the spiral resonator 1400 of FIGS. 14A-14C. The spiral resonator 1400 is situated within a 1.276-meter acoustic duct, exposed to a sound pressure level (SPL) of 138 decibels. The third experiment established a stable condition inside the spiral resonator 1400 after a 30-minute equilibration period. A significant dual-resonance phenomenon was observed, with a first peak 1512 indicating the fundamental resonance frequency. The fundamental resonance frequency was deduced to be lower than expected due to the extension created by the outer spirals 1404a-d, resulting in an approximate fundamental frequency of 133.56 Hz. A second peak 1516 registered at roughly 146.66 Hz is attributable to a higher resonance mode influenced by additional length from the inner spiral channels 1404e-g.

Referring now to FIG. 16, shown therein is a partially exploded perspective view of an exemplary embodiment of a spiral stack 1600 constructed in accordance with the present disclosure. The spiral stack 1600 comprises a plurality of helical pores 1604. Each helical pore 1604 may have a cross-sectional shape and dimension and a position apart from adjacent helical pores based on a particular wavelength as described above. For example, each helical pore 1604 may have a circular cross-section with a diameter of 0.002 m, and each helical pore 1604 may be disposed approximately 0.001 m apart from each other helical pores 1604. In one embodiment, the spiral stack 1600 may be an exemplary embodiment of the porous stack 14.

In one embodiment, the helical pores 1604 may be arranged in layers 1608a-n. Each layer 1608 may be a region of the spiral stack 1600 within a particular radius from a longitudinal axis, a, of the spiral stack 1600. Thus, as the layers 1608 are disposed further from the longitudinal axis, a, (e.g., outer layers 1608) the helical pores 1604 in the further layers 1608 have a greater length than the nearer layers 1608 (e.g., inner layers 1608). For example, a first plurality of helical pores 1604 may be arranged in a first layer 1608a and a second plurality of helical pores 1604 may be arranged in a second layer 1608b. In this way, the first plurality of helical pores 1604 in the first layer 1608a may have a greater length than the second plurality of helical pores 1604 in the second layer 1608b, thereby further augmenting interaction with the sound waves passing through the spiral stack 1600.

In one embodiment, the variation in length of the helical pores 1604 allows the spiral stack 1600 to resonate across a broader spectrum of acoustic frequencies, thereby capturing a wider array of resonant points that contribute to the overall effectiveness of the spiral stack 1600.

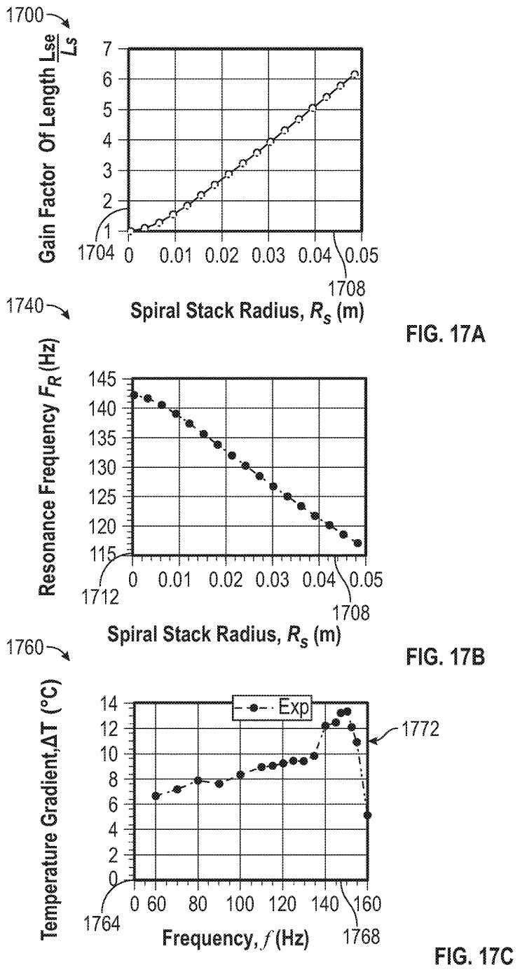

Referring now to FIG. 17A, shown therein is a diagram of an exemplary embodiment of a graph 1700 constructed in accordance with the present disclosure and a fourth experiment. The graph 1700 illustrates a relationship between varying spiral stack radii 1708 and a gain factor 1704 of length. In the fourth experiment, the spiral stack 1600 maintains a constant pitch of 0.0025 m, completes one revolution, and stands 0.50 m tall. As shown in FIG. 17A, as the spiral stack 1600 radius increases, the gain factor 1704 of the equivalent linear length also increases. This is believed to be because the helical geometry extends the path that the sound waves travel within the helical pores 1604, effectively lengthening the acoustic path within the spiral stack 1600 without increasing the physical length of the resonator into which the spiral stack 1600 is placed.

Referring now to FIG. 17B, shown therein is a diagram of an exemplary embodiment of a graph 1740 constructed in accordance with the present disclosure and a fourth experiment. The graph 1740 illustrates a relationship between varying spiral stack radii 1708 and a resonance frequency 1712. As shown by the graph 1740, as the radius 1708 increases, the resonance frequency 1712 decreases. This reduction in frequency is a believed to be a consequence of the increased acoustic path length whereby longer paths result in lower resonant frequencies.

Referring now to FIG. 17C, shown therein is a diagram of an exemplary embodiment of a graph 1760 constructed in accordance with the present disclosure and a fourth experiment. The graph 1760 illustrates experimental data for a temperature gradient 1764 for given frequencies 1768. Unlike straight stacks that exhibit sharp peaks at specific resonance frequencies, the spiral stack 1600 demonstrates a broader, more distributed response across a wider frequency range. This behavior is attributed to the spiral design's variable effective acoustic path lengths, which are dependent on the radial positioning of the helical pores 1604. In this configuration, the helical pores 1604 in the outer layers 1608 have longer path lengths compared to the helical pores 1604 in the inner layers 1608, resulting in a range of effective resonance lengths rather than a single, distinct length. Consequently, the helical pores 1604 of the spiral stack 1600 do not produce a singular, sharp peak in the temperature gradient 1764 at a specific frequency. Instead, complex geometry allows for multiple resonant modes to occur at slightly different frequencies, thereby flattening a temperature gradient profile 1772 across a broader range of frequencies. This broadband response showcases the helical pores 1604 of the spiral stack 1600 may maintain thermal performance over a range of frequencies rather than concentrating performance around a narrow band of frequencies.

Referring now to FIG. 18A, shown therein is a partially transparent perspective view of an exemplary embodiment of a modular resonator 1800 constructed in accordance with the present disclosure. The modular resonator 1800 may comprise a plurality of sections 1804, shown in FIG. 18A as eight section 1804 for illustrative purposes only. The plurality of sections 1804 may be defined by respective walls 1808 extending radially from a longitudinal axis, b, and along a length, l, of the modular resonator 1800 to a support 1810. Each section 1804 may have disposed therein a stack 1812 and an end-plate 1816. For example, as shown in FIG. 18A, a section 1804a may may be defined by a first wall 1808a and a second wall 1808b and have disposed therein a first stack 1812a and a first end-plate 1816a. In one embodiment, the modular resonator 1800 may be an exemplary embodiment of the resonator 18. In one embodiment, the stack 1812 may be constructed in accordance with any of the stacks described herein, such as the porous stack 14.

In one embodiment, the end-plate 1816 may be positionable within a particular section 1804 along the longitudinal axis, b, of the modular resonator 1800. In this way, a length of each section 1804 may be variable and the respective stack 1812, positionable within the section 1804 may be disposed at a particular distance from the end-plate 1816 or opening 1820, thereby adjusting the resonance frequency of each section 1804. In this way, each section 1804 may resonate at a different frequency, resulting in the modular resonator 1800 operable over a broad range of frequencies and enabling ambient acoustic absorption and energy harvesting.

Referring now to FIG. 18B, shown therein is a top view of an exemplary embodiment of the stack 1812 constructed in accordance with the present disclosure. The stack 1812 is shown having a plurality of pores 1840. In one embodiment, the plurality of pores 1840 defined by supports 1844. Each pore 1840 may have a cross-section dimension of about 0.002 m and may have a cross-sectional shape, such as a rectangle, circle, oval, ellipse, triangle, or any fanciful shape operable to guide acoustic waves as disclosed herein. The supports 1844 may have a width or thickness of about 0.001 m.

Referring now to FIG. 18C, shown therein is a perspective view of an exemplary embodiment of the stack 1812 constructed in accordance with the present disclosure.

Referring to FIGS. 18A-18C, in one embodiment, the modular resonator 1800 is tuned so that each section 1804 resonates at a specific point within a broader acoustic spectrum. The support 1810 of the modular resonator 1800 may be fabricated using an FDM process with a material such as PLA. Each stack 1812 may be constructed using an SLA process of a resin material. When using the SLA process to print the stacks 1812, a layer height of the print may be 100 μm. Each stack 1812 may have a height of 0.025 m and may be printed separately. The support 1810 may have a diameter of 0.1 m, giving each section 1804 a triangular/pie shape. The stack 1812 within each section 1804 is characterized by a square geometry of the pores 1840.

It should be understood that while FDM and SLA manufacturing processes are described herein, a person skilled in the art would recognize that other manufacturing processes may, either additionally or alternatively, be used. The other manufacturing processes may be those used for rapid prototyping or may be traditional manufacturing techniques such as injection molding or CNC machining, for example.

In addition to use as the TAMS barrier 400, the stacks described herein (e.g., the stacks 14, the spiral stacks 1404, the spiral stacks 1600, the stacks 1812) may be implemented in additional or alternative configurations for noise control. For example, traditionally, acoustic liners are widely used for noise control in various applications, such as in aircraft jet engines, civil or transportation infrastructures, and turbomachinery. These liners are usually constructed from lightweight and porous materials such as perforate over honeycomb or foam structures, which reduce sound energy through various absorptive mechanisms. Despite their widespread use, conventional acoustic liners have limitations, including narrow, high-frequency bandwidths of effectiveness, limited adaptability to varying source characteristics, and unexploited potential for multifunctional applications like energy harvesting, sensing, and monitoring.

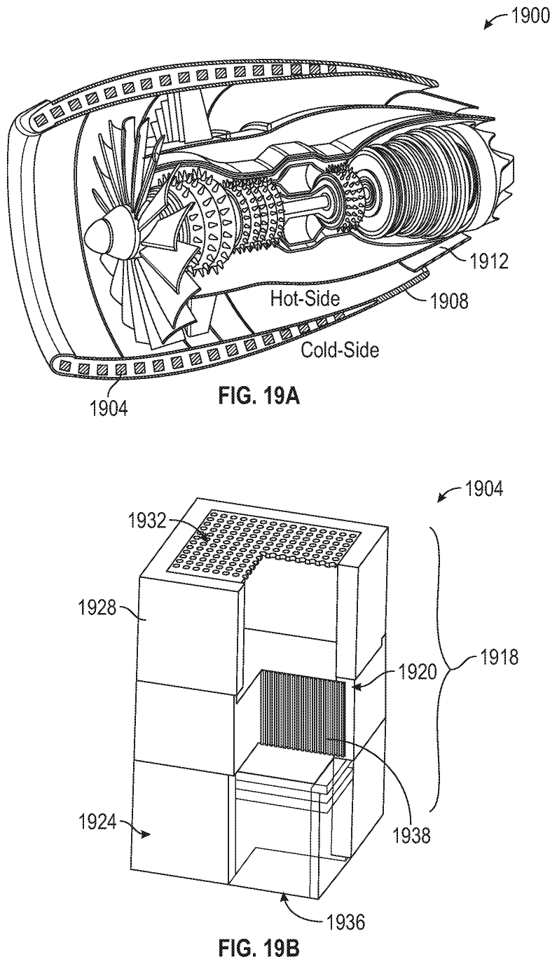

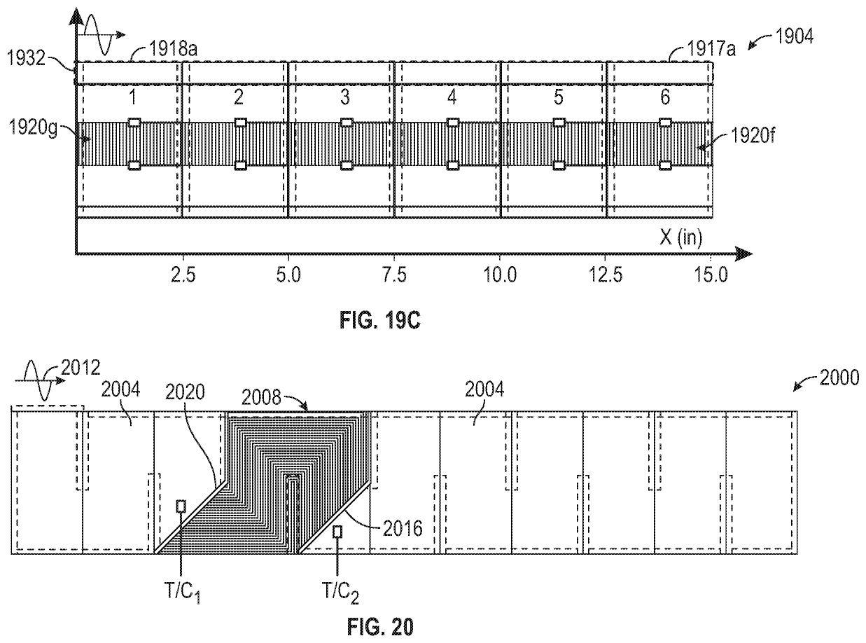

Referring now to FIG. 19A, shown therein is an illustration of an exemplary embodiment of a jet engine 1900 constructed in accordance with the present disclosure. The jet engine 1900 may be constructed as a typical jet engine except that a conventional acoustic liner of the jet engine 1900 may be replace with a thermoacoustic liner 1904 disposed between an outside 1908 (e.g., cold side) and an inside 1912 (e.g., hot side) of the jet engine 1900.

Referring now to FIG. 19B, shown therein is a perspective cut-away view of a portion of an exemplary embodiment of the thermoacoustic liner 1904 of FIG. 19A constructed in accordance with the present disclosure. The thermoacoustic liner may comprise a resonator 1918 having a stack 1920, a core 1924, a resonance chamber 1928, a face-sheet 1932, and an end-stop 1936. A location of the stack 1920 within the resonator 1918 (e.g., position of the stack as measured from the face-sheet 1932) controls a pressure differential across the stack 1920 which impacts how well heat is transferred between the working fluid to the end-stop 1936. The length of the stack 1920 plays a role in determining a magnitude of the pressure oscillations and thermal transients in the working fluid, which can influence the stability and efficiency of the thermoacoustic liner 1904. In general, optimizing the location and length of the stack 1920 can lead to improved acoustic and thermoacoustic performance of the thermoacoustic liner 1904. In one embodiment, the resonator 1918 may be constructed in accordance with any of the resonator 18 described herein. In one embodiment, the stack 1920 may be constructed in accordance with any of the porous stack 14 described herein.

In one embodiment, the length of the resonator 1918 of the thermoacoustic liner 1904 is between about 0.09 m and 1.1 m, or about 0.097 m (3.9 in). The stack 1920 may be located at a location between 30-60% of the length of the resonator 1918 from the face-sheet 1932, and preferable just short of a midpoint of the resonator 1918, or at about 0.04 m. The stack 1920 may have a cross-sectional dimension of between about 0.05 m and 0.07 m or about 0.064 m. Each pore 1938 of the stack 1920 may have a cross-sectional dimension of about 0.001 m and the stack 1920 may have a length of between about 0.025 m and 0.035 m, or about 0.031 m.

In one embodiment, as shown in FIG. 19C, the thermoacoustic liner 1904 comprises a plurality of resonators 1918 disposed adjacent to each other. When the thermoacoustic liner 1904 comprises the plurality of resonators 1918, the thermoacoustic liner 1904 may have one face-sheet 1932 extending across one or more resonator 1918 of the plurality of resonators 1918. In some embodiments, one or more of the stacks 1920 may be placed at different locations along respective resonators 1918. In experimentation, a peak temperature gradient of approximately 9.5° C. was achieved at a resonance frequency of 790 Hz using the thermoacoustic liner 1904 with stack 1920 positioned near the middle of the resonator 1918.

Referring now to FIG. 20, shown therein is a diagram of an exemplary embodiment of a folded-core thermoacoustic liner 2000 constructed in accordance with the present disclosure. The folded-core thermoacoustic liner 2000 comprises a plurality of modular resonator blocks 2004 and a folded-core stack 2008. The folded-core thermoacoustic liner 2000 enables adaptable configurations for tailoring resonance of the folded-core thermoacoustic liner 2000 to varying acoustic frequencies. In one embodiment, the folded-core stack 2008 may be an exemplary embodiment of the porous stack 14 as disclosed herein, and each modular resonator block 2004 may be exemplary embodiments of the resonator 18 described herein.

As speed of flow 2012 increases, marked by an increment in Mach number, a temperature difference across a first side 2016 (hot side) and a second side 2020 (cold side) of the folded-core stack 2008 exhibits distinctive trends. At no flow condition (M=0), the temperature difference plateaus, suggesting equilibrium is achieved without the influence of convective forces. As the Mach number increases to 0.3, a maximum temperature gradient of 1.31° C. is observed, highlighting an optimal condition for thermoacoustic conversion where the flow aids in energy transfer without substantial convective cooling. Further increase in the flow speed (M=0.5) demonstrates a decrease in the temperature gradient, indicating a threshold beyond which convective effects dominate and disrupt the thermoacoustic energy conversion of the folded-core thermoacoustic liner 2000, likely due to the increased cooling of the first side 2016 and the second side 2020.

Further, as static pressure is increased, thermoacoustic performance of the folded-core stack 2008 is enhanced. A temperature gradient of 1.31° C. is achieved at a static pressure of 15 PSI. This behavior underscores the sensitivity of the folded-core thermoacoustic liner 2000 to environmental conditions.

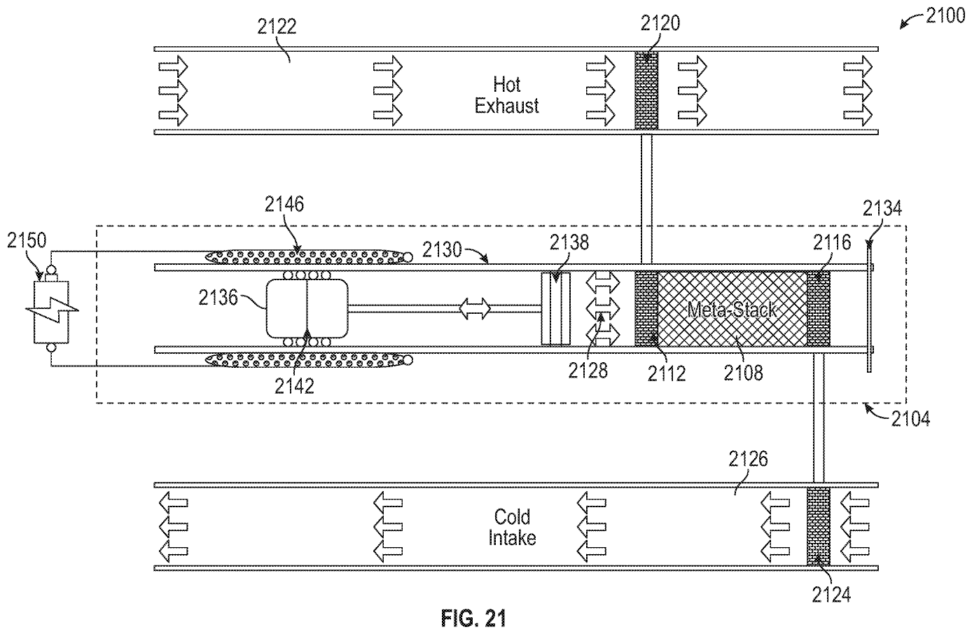

Referring now to FIG. 21, shown therein is a diagram of an exemplary embodiment of a thermoacoustic system 2100 constructed in accordance with the present disclosure. The thermoacoustic system 2100 may harvest useable electric power from ambient thermal gradients available in several application scenarios. The thermoacoustic system 2100 may include a TAMS harvester 2104 for internal combustion (IC) engines. Here, a meta-stack may be disposed between a hot-side heat exchanger 2112 and a cold-side heat exchanger 2116. A hot-side heat exchanger pickup 2120 may collect heat from a hot exhaust 2122 of an internal combustion engine. Similarly, a cold-side heat exchanger pickup 2124 may be in contact with a cold air intake 2126. The hot-side heat exchanger pickup 2120 and the cold-side heat exchanger pickup 2124 may be constructed of materials with high thermal conductivity such as copper. In this way, the hot-side heat exchanger pickup 2120 and the cold-side heat exchanger pickup 2124 may scavenge waste heat from the IC engine to setup a thermal gradient across the meta-stack 2108. In one embodiment, the meta-stack 2108 may be a thermoacoustic stack having a porous stack constructed in accordance with any of the stacks 14 described herein.

This arrangement sets up an acoustic wave 2128 corresponding to a resonance frequency of a resonator 2130 which can be tuned for varying temperature gradients through the use of a tunable tensioned (stretched) membrane 2134 boundary condition at one end of the resonator 2130. The resonator 2130 may be constructed in accordance with any of the resonators 18 described herein except as described below. The energy of the acoustic wave could be harnessed using a linear electro-mechanical generator 2136 having a low-friction reciprocating piston 2138 attached to a permanent magnet 2142 that couples electromechanically with generating coils 2146 to produce electric power. The harvested power can be stored in-situ in rechargeable batteries 2150 that supplement main batteries of a system powered by the IC engine.

Referring now to FIGS. 22A-22C, in combination, shown therein is a diagram of an exemplary embodiment of a thermoacoustic system 2200 constructed in accordance with the present disclosure. The thermoacoustic system 2200 may harvest useable electric power from ambient thermal gradients available in several application scenarios. The thermoacoustic system 2200 may include a TAMS harvester 2204 for infrastructural applications. Owing to the availability of a significant temperature gradient between the external and internal areas of built environments (e.g., structure 2208) over extensive periods around the year in most locations, TAMS harvesters 2204 are well-suited for infrastructural applications.

In one embodiment, external thermal pickup surfaces (e.g., a hot-side heat exchanger pickup 2212 and a cold-side heat exchanger pickup 2216) could be integrated with architectural or structural features 2220 such as windows. The structural features 2220 may also be designed to pivot towards a thermal source such as by tracking the movement of the sun or wind patterns to optimize the efficiency of the hot-side heat exchanger pickup 2212. Similarly the cold-side heat exchanger pickup 2216 can be multifunctionalized with interior architectural or structural features.

In one embodiment, the TAMS harvester 2204 is disposed within a wall of the structure 2208. The TAMS harvester 2204 comprises a resonator 2224 equipped with a meta-stack 2226 interfacing with heat exchangers (e.g., a first heat (hot-side) exchanger 2230 and a second (cold-side) heat exchanger 2234), leading to generation of an acoustic wave 2238. In one embodiment, the meta-stack 2226 may be a thermoacoustic stack having a porous stack constructed in accordance with any of the stacks 14 described herein. The resonator 2224 may be constructed in accordance with any of the resonators 18 described herein.

In one embodiment, an intensity of the acoustic wave 2238 may be enhanced through use of a pressurized inert gas 2242 as the working fluid.

In one embodiment, to improve compactness and mechanical durability, a magnet-loaded tensioned membrane 2246 (hereinafter membrane 2246) may be employed as a multifunctional kernal that couples with generating coils 2250 to produce electric power.

In one embodiment, a tuning chamber 2254 behind the membrane 2246 could be pressurized differentially to tune a resonant response of the membrane 2246 in sync with the acoustic wave 2238 generated from the thermal gradient. The harvested power could be used to sustain low-power electronic devices within the building, such as via a charging port 2256 or to supplement the building's electrical system. Further, the harvested power may be provided to, and stored within, a battery system 2258, such as the power circuitry 504 (FIG. 5D).

In some embodiments, the TAMS harvester 2204 may further include a thermal and acoustic insulation 2260 disposed between each of the hot-side heat exchanger pickup 2212 and the cold-side heat exchanger pickup 2216 and the resonator 2224.

### ILLUSTRATIVE CLAUSES

Following is a non-limiting list of illustrative clauses of the present disclosure.
Clause 1. A thermoacoustic metastructure comprising:
a resonator comprising a surrounding wall defining an opening, the surrounding wall having a first end and a second end opposite the first end, the first end forming an aperture operable to receive a working fluid, the second end forming an end-stop, the resonator having a resonator length between the first end and the second end of the surrounding wall;
a porous stack having a first side and a second side opposite the first side and having a plurality of pores disposed therethrough, the porous stack disposed in the opening defined by the surrounding wall of the resonator and in fluid communication with the working fluid; and
a thermopile comprising a plurality of thermoelectric transducers electrically coupled to form a thermopile circuit operable to generate electrical energy, the thermoelectric transducers being coupled to a first location and a second location of the porous stack, the first location longitudinally spaced from the second location.
Clause 2. The thermoacoustic metastructure of clause 1, wherein each pore of the plurality of pores has a pore width of two to four times a thermal and viscous penetration depth of the working fluid.
Clause 3. The thermoacoustic metastructure of any one of clauses 1 or 2, further comprising a perforated face-sheet disposed over the aperture of the first end of the resonator.
Clause 4. The thermoacoustic metastructure of any one of clauses 1-3, wherein the end-stop forms an acoustically-rigid termination of the resonator.
Clause 5. The thermoacoustic metastructure of any one of clauses 1-4, further comprising: a power circuitry electrically coupled to the thermopile and operable to receive the generated electrical energy, wherein the power circuitry is further operable to modulate the generated electrical energy into an electrical output having a predetermined voltage.
Clause 6. The thermoacoustic metastructure of clause 5, wherein the power circuitry further comprises a battery circuitry operable to receive the generated electrical energy from the thermopile circuit and store at least a portion of the generated electrical energy in a battery.
Clause 7. The thermoacoustic metastructure of any one of clauses 1-6, wherein the porous stack further comprises a first heat exchanger disposed on the first side and a second heat exchanger disposed on the second side, and wherein the thermoelectric transducers are alternatingly coupled to the first heat exchanger and the second heat exchanger.
Clause 8. The thermoacoustic metastructure of any one of clauses 1-7, wherein at least one of the resonator and the porous stack is manufactured with a 3D printing process.
Clause 9. The thermoacoustic metastructure of any one of clauses 1-8, wherein the thermopile further comprises a first plurality of thermopile wires having a first type and a second plurality of thermopile wires having a second type, the first and second plurality of thermopile wires being alternatingly, electrically disposed between adjacent thermoelectric transducers of the thermopile circuit.
Clause 10. The thermoacoustic metastructure of clause 9, wherein the thermoelectric transducers are thermocouples.
Clause 11. The thermoacoustic metastructure of any one of clauses 1-10, wherein the thermopile circuit comprises between 300 and 500 thermoelectric transducers.
Clause 12. The thermoacoustic metastructure of any one of clauses 1-11, wherein the porous stack is disposed at a location between 30% and 50% of the resonator length from the first end.
Clause 13. The thermoacoustic metastructure of any one of clauses 1-12, further comprising a plurality of porous stacks, and wherein the resonator further comprises a plurality of openings defined by the surrounding wall, the plurality of porous stacks each disposed within respective ones of the plurality of openings.
Clause 14. The thermoacoustic metastructure of clause 13, wherein the plurality of openings are helical openings and the plurality of porous stacks are spiral stacks, the helical openings operable to receive respective ones of the spiral stacks.
Clause 15. The thermoacoustic metastructure of clause 14, wherein the helical openings has one rotation around a longitudinal axis of the resonator along the resonator length and extending through the first side and the second side of the resonator.
Clause 16. The thermoacoustic metastructure of clause 13, further comprising a first plurality of openings having a first length and a second plurality of openings having a second length different from the first length.
Clause 17. The thermoacoustic metastructure of any one of clauses 1-16, wherein the thermoelectric transducers are alternatingly coupled to the first location and the second location of the porous stack.
Clause 18. An infrastructural barrier comprising: a plurality of thermoacoustic metastructures, each thermoacoustic metastructure comprising:
a resonator having a surrounding wall defining an opening, the surrounding wall having a first end and a second end opposite the first end, the first end forming an aperture operable to receive a working fluid, the second end forming an end-stop, the resonator having a resonator length between the first end and the second end;
a porous stack having a first side and a second side opposite the first side, the porous stack disposed in the opening defined by the surrounding wall and in fluid communication with the working fluid;
a thermopile comprising a plurality of thermoelectric transducers electrically coupled to form a thermopile circuit operable to generate electrical energy, the thermoelectric transducers being alternatingly coupled to a first location and a second location of the porous stack, the first location being spaced longitudinally from the second location; and
a modular housing supporting the resonator, the porous stack, and the thermopile; and
at least one power circuitry electrically coupled to the thermopile circuit of one or more thermoacoustic metastructure and operable to receive the generated electrical energy; and
wherein the modular housing of each of the plurality of thermoacoustic metastructures is interlocked with at least one adjacent thermoacoustic metastructure.
Clause 19. The infrastructural barrier of clause 18, wherein a first thermoacoustic metastructure of the plurality of thermoacoustic metastructures has the porous stack tuned to a first resonant frequency and a second thermoacoustic metastructure of the plurality of thermoacoustic metastructures has the porous stack tuned to a second resonant frequency.
Clause 20. The infrastructural barrier of any one of clauses 18-19, wherein a first thermoacoustic metastructure of the plurality of thermoacoustic metastructures has the porous stack at a first distance within the resonator of the first thermoacoustic metastructure; and a second thermoacoustic metastructure of the plurality of thermoacoustic metastructures has the porous stack at a second distance within the resonator of the second thermoacoustic metastructure, the second distance being different than the first distance.
Clause 21. The infrastructural barrier of any one of clauses 18-20, further comprising a perforated face-sheet disposed over the aperture of the first end of the resonator of one or more thermoacoustic metastructure of the plurality of thermoacoustic metastructures.
Clause 22. A method of making a thermoacoustic metastructure, comprising: in any order,
positioning a porous stack having first and second ends into a resonator; and
connecting a thermopile to a first location and a second location of the porous stack, the first location being longitudinally spaced from the second location.
Clause 23. A method of using the thermoacoustic metastructure of any one of clauses 1-16, or 22, comprising:
placing the resonator proximate a sound source; and
receiving sound waves through a first end of the resonator to cause a temperature gradient to form between the first location and the second location whereby the thermopile generates electrical energy based upon the temperature gradient.
Clause 24. The method of clause 23, further comprising supplying the electrical energy to power circuitry.

### CONCLUSION

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the the inventive concepts disclosed and claimed herein.

Further, within the above description, experimentation is described. However, specific values of the various experimentation are provided for exemplary purposes and should not be read to limit the present disclosure.

What is claimed is:

1. A thermoacoustic metastructure comprising:
a resonator comprising a surrounding wall defining an opening, the surrounding wall having a first end and a second end opposite the first end, the first end forming an aperture operable to receive a working fluid, the second end forming an end-stop, the resonator having a resonator length between the first end and the second end of the surrounding wall;
a porous stack having a first side and a second side opposite the first side and having a plurality of pores disposed therethrough, the porous stack disposed in the opening defined by the surrounding wall of the resonator and in fluid communication with the working fluid, the porous stack having a non-uniform pore geometry along at least one direction of the stack; and
a thermopile comprising a plurality of thermoelectric transducers electrically coupled to form a thermopile circuit operable to generate electrical energy, the thermoelectric transducers being coupled to a first location and a second location of the porous stack, the first location longitudinally spaced from the second location.

2. The thermoacoustic metastructure of claim 1, wherein each pore of the plurality of pores has a pore width of two to four times a thermal and viscous penetration depth of the working fluid.

3. The thermoacoustic metastructure of claim 1, further comprising a perforated face-sheet disposed over the aperture of the first end of the resonator.

4. The thermoacoustic metastructure of claim 1, wherein the end-stop forms an acoustically-rigid termination of the resonator.

5. The thermoacoustic metastructure of claim 1, further comprising:
a power circuitry electrically coupled to the thermopile and operable to receive the generated electrical energy, wherein the power circuitry is further operable to modulate the generated electrical energy into an electrical output having a predetermined voltage.

6. The thermoacoustic metastructure of claim 5, wherein the power circuitry further comprises a battery circuitry operable to receive the generated electrical energy from the thermopile circuit and store at least a portion of the generated electrical energy in a battery.

7. The thermoacoustic metastructure of claim 1, wherein the porous stack further comprises a first heat exchanger disposed on the first side and a second heat exchanger disposed on the second side, and wherein the thermoelectric transducers are alternatingly coupled to the first heat exchanger and the second heat exchanger.

8. The thermoacoustic metastructure of claim 1, wherein at least one of the resonator and the porous stack is manufactured with a 3D printing process.

9. The thermoacoustic metastructure of claim 1, wherein the thermopile further comprises a first plurality of thermopile wires having a first type and a second plurality of thermopile wires having a second type, the first and second plurality of thermopile wires being alternatingly, electrically disposed between adjacent thermoelectric transducers of the thermopile circuit.

10. The thermoacoustic metastructure of claim 9, wherein the thermoelectric transducers are thermocouples.

11. The thermoacoustic metastructure of claim 1, wherein the thermopile circuit comprises between 300 and 500 thermoelectric transducers.

12. The thermoacoustic metastructure of claim 1, wherein the porous stack is disposed at a location between 30% and 50% of the resonator length from the first end.

13. The thermoacoustic metastructure of claim 1, further comprising a plurality of porous stacks, and wherein the resonator further comprises a plurality of openings defined by the surrounding wall, the plurality of porous stacks each disposed within respective ones of the plurality of openings.

14. The thermoacoustic metastructure of claim 13, wherein the plurality of openings are helical openings and the plurality of porous stacks are spiral stacks, the helical openings operable to receive respective ones of the spiral stacks.

15. The thermoacoustic metastructure of claim 14, wherein the helical openings has one rotation around a longitudinal axis of the resonator along the resonator length and extending through the first side and the second side of the resonator.

16. The thermoacoustic metastructure of claim 13, further comprising a first plurality of openings having a first length and a second plurality of openings having a second length different from the first length.

17. The thermoacoustic metastructure of claim 1, wherein the thermoelectric transducers are alternatingly coupled to the first location and the second location of the porous stack.

18. The thermoacoustic metastructure of claim 1, wherein the pores create a first zone tuned to a first frequency, and a second zone tuned to a second frequency, with the first and second frequencies being different.

19. An infrastructural barrier comprising:
a plurality of thermoacoustic metastructures, each thermoacoustic metastructure comprising:
a resonator having a surrounding wall defining an opening, the surrounding wall having a first end and a second end opposite the first end, the first end forming an aperture operable to receive a working fluid, the second end forming an end-stop, the resonator having a resonator length between the first end and the second end;
a porous stack having a first side and a second side opposite the first side, the porous stack disposed in the opening defined by the surrounding wall and in fluid communication with the working fluid;
a thermopile comprising a plurality of thermoelectric transducers electrically coupled to form a thermopile circuit operable to generate electrical energy, the thermoelectric transducers being alternatingly coupled to a first location and a second location of the porous stack, the first location being spaced longitudinally from the second location; and
a modular housing supporting the resonator, the porous stack, and the thermopile; and
at least one power circuitry electrically coupled to the thermopile circuit of one or more thermoacoustic metastructure and operable to receive the generated electrical energy; and
wherein the modular housing of each of the plurality of thermoacoustic metastructures is interlocked with at least one adjacent thermoacoustic metastructure.

20. The infrastructural barrier of claim 19, wherein a first thermoacoustic metastructure of the plurality of thermoacoustic metastructures has the porous stack tuned to a first resonant frequency and a second thermoacoustic metastructure of the plurality of thermoacoustic metastructures has the porous stack tuned to a second resonant frequency.

21. The infrastructural barrier of claim 19, wherein
a first thermoacoustic metastructure of the plurality of thermoacoustic metastructures has the porous stack at a first distance within the resonator of the first thermoacoustic metastructure; and
a second thermoacoustic metastructure of the plurality of thermoacoustic metastructures has the porous stack at a second distance within the resonator of the second thermoacoustic metastructure, the second distance being different than the first distance.

22. The infrastructural barrier of claim 19, further comprising a perforated face-sheet disposed over the aperture of the first end of the resonator of one or more thermoacoustic metastructure of the plurality of thermoacoustic metastructures.

23. A method of making a thermoacoustic metastructure, comprising:
in any order,
positioning a porous stack having first and second ends into a resonator, the porous stack having a non-uniform geometry along at least one direction of the stack; and
connecting a thermopile to a first location and a second location of the porous stack, the first location being longitudinally spaced from the second location.

24. The method of claim 23, wherein positioning the porous stack is defined further as positioning the porous stack with the porous stack defining pores to create a first zone tuned to a first frequency, and a second zone tuned to a second frequency, with the first and second frequencies being different.

25. A method of using the thermoacoustic metastructure of claim 1, comprising:
placing the resonator proximate a sound source; and
receiving sound waves through a first end of the resonator to cause a temperature gradient to form between the first location and the second location whereby the thermopile generates electrical energy based upon the temperature gradient.

26. The method of claim 25, further comprising supplying the electrical energy to power circuitry.
